(19) United States
(12) Patent Application Publication
(10) Pub. No.: US 2012/0036080 A1
(43) Pub. Date: Feb. 9, 2012

(54) METHOD AND SYSTEM FOR TRACKING ONLINE SOCIAL INTERACTIONS

(75) Inventors: Niv Singer, Tel Aviv (IL); Yaniv Ben-Arie, Tel Aviv (IL)

(73) Assignee: TRACX SYSTEMS LTD., Tel-Aviv (IL)

(21) Appl. No.: 13/263,001

(22) PCT Filed: Apr. 6, 2010
(86) PCT No.: PCT/IL10/00287

§ 371 Date: Oct. 5, 2011

Related U.S. Application Data
(60) Provisional application No. 61/166,943, filed on Apr. 6, 2009.

(51) Int. Cl. G06Q 99/00; G06N 5/02; G06N 5/00

(52) U.S. Cl. 705/319; 706/46; 706/52

(57) ABSTRACT

Systems and methods of tracking online social interactions. In various instances, tracking may include any of the following inter-alia: ranking user accounts, identifying corresponding user accounts, noting online roles of user accounts and/or calculating the alternative cost of funding a traditional online campaign equivalent in exposure and partiality. In some cases, tracking may be used as part of end to end management of a campaign (e.g. advertisement, marketing, public relations, political, etc.)

### CROSS REFERENCE TO RELATED APPLICATIONS

This application claims the benefit of U.S. Provisional Application No. 61/166,943 filed Apr. 6, 2009, which is hereby incorporated by reference herein.

### FIELD OF THE INVENTION

The present invention relates to the field of online social interactions.

### BACKGROUND OF THE INVENTION

The phrase Web 2.0 refers to the second generation of web-based communities, such as social networking sites, wikis, blogs, etc, which aim to facilitate interactions among users.

### SUMMARY OF THE INVENTION

According to the invention, there is provided a method of ranking an online user account, comprising: ranking each of a group of posts owned by a user account as a function of quantity of online interactions with the post; and ranking the user account as a function of the rank of each post owned by the user account in the group.

According to the invention, there is also provided a system for ranking an online user account comprising: at least one post ranker for ranking each of a group of posts owned by a user account as a function of quantity of online interactions with the post; and at least one user account ranker for ranking the user account as a function of the rank of each post owned by the user account in the group.

According to the invention, there is further provided a method of concluding that two online user accounts correspond to a common profile, comprising: analyzing data relating to two online user accounts; increasing a probability that the two online user accounts correspond to a common profile as more of the data suggests that the two user accounts correspond to a common profile; and if a probability that the two online user accounts correspond to a common profile is above a predetermined threshold, concluding that the two online user accounts correspond to a common profile.

According to the invention, there is still further provided a system for concluding that two online user accounts correspond to a common profile, comprising: at least one counter for increasing a probability that two online user accounts correspond to a common profile as more data relating to two online user accounts suggests that the two user accounts correspond to a common profile; and at least one comparer for analyzing data relating to two online user accounts and for concluding that the two online user accounts correspond to a common profile, if a probability that the two online user accounts correspond to a common profile is above a predetermined threshold.

According to the invention, there is provided a method of noting online roles of user accounts, comprising: for at least one post from a group of posts: noting at least one role played by a user account which owns the post; and for at least one interaction from a collection of interactions with the post, noting at least one role played by associated interacting user account based on type of interaction.

According to the invention, there is also provided a system for noting online roles of user accounts, comprising: at least one counter for noting for at least one post from a group of posts at least one role played by a user account which owns the post; and for noting for at least one interaction from a collection of interactions with the post, at least one role played by associated interacting user account based on type of interaction.

According to the invention, there is further provided a method of calculating alternative cost of funding a traditional online campaign that would lead to equivalent exposure with equivalent partiality as posts, comprising: for each post relevant to an online campaign: determining a partiality score of the post to the campaign; and estimating cost of funding in a traditional campaign equivalent exposure at external source including post; and calculating the alternative cost by summing the partiality score multiplied by the estimated cost for each post.

According to the invention there is still further provided a system for calculating alternative cost of funding a traditional online campaign that would lead to equivalent exposure with equivalent partiality as posts, comprising: at least one partiality scorer for determining a partiality score for each post relevant to an online campaign; at least one traditional campaign cost estimator for estimating for each post a cost of funding in a traditional campaign equivalent exposure at external source which includes the post; and at least one alternative cost calculator for calculating an alternative cost by summing the partiality score multiplied by the estimated cost for each post.

According to the invention, there is provided a method of management of an online campaign, comprising: receiving a definition of a campaign; selecting a subset of posts based on the definition; and reporting at least one of the following: at least one user account, the reporting reflecting user account rank as a function of rank of each post owned by the user account in the subset; a user account who played a specific role as a post owner or interacting user account for at least one post in the subset; a profile corresponding with a probability above a predetermined threshold to at least one user account, each of which owns or interacted with at least one post in the subset; or an alternative cost of funding a traditional online campaign that would lead to equivalent exposure with equivalent partiality as the subset of posts.

According to the invention, there is also provided a system for management of an online campaign, comprising: an application for receiving a definition of a campaign; an index searcher for searching an index to select a subset of posts based on the definition; and a reporting module for reporting at least one of the following: at least one user account, the reporting reflecting user account rank as a function of rank of each post owned by the user account in the subset; a user account who played a specific role as a post owner or interacting user account for at least one post in the subset; a profile corresponding with a probability above a predetermined threshold to at least one user account, each of which owns or interacted with at least one post in the subset; or an alternative cost of funding a traditional online campaign that would lead to equivalent exposure with equivalent partiality as the subset of posts.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a network including a system for tracking social interactions, according to some embodiments of the invention;

FIG. 2 is an example of an interactions graph, according to some embodiments of the invention;

FIG. 3 is a block diagram of a worker module, according to some embodiments of the invention;

FIG. 4 is a flowchart of a method of ranking user accounts, according to some embodiments of the invention;

FIG. 5 is a flowchart of a method of keeping track of roles played by user accounts with respect to a trend, according to some embodiments of the invention;

FIG. 6 illustrates graphs of the number of posts and interactions per day and graphs of the running average deltas of posts and interactions, according to some embodiments of the invention;

FIG. 7 is an example of a social graph, according to some embodiments of the invention;

FIG. 8 is a flowchart of a method for identifying corresponding user accounts, according to some embodiments of invention;

FIG. 9 is a screenshot of a page in Google Social Graph API, according to some embodiments of the invention;

FIG. 10 is a flowchart of a method of campaign management, according to some embodiments of the invention;

FIG. 11 is a screenshot illustrating some aspects of campaign definition, according to some embodiments of the invention;

FIG. 12 is a screenshot illustrating some aspects of campaign reporting, according to some embodiments of the invention;

FIG. 13 is another screenshot illustrating some aspects of campaign reporting, according to some embodiments of the invention;

FIG. 14 is another screenshot illustrating some aspects of campaign reporting, according to some embodiments of the invention;

FIG. 15 is another screenshot illustrating some aspects of campaign reporting, according to some embodiments of the invention;

FIG. 16 is another screenshot illustrating some aspects of campaign reporting, according to some embodiments of the invention;

FIG. 17 is another screenshot illustrating some aspects of campaign reporting, according to some embodiments of the invention;

FIG. 18 is a graph illustrating the rank of one user account converging with each iteration, according to some embodiments of the invention; and

FIG. 19 is a flowchart of a method of calculating an alternative campaign cost, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “ranking”, “weighting”, “normalizing”, “determining”, “sorting”, “filtering”, “analyzing”, “increasing”, “concluding”, “creating”, “noting”, “estimating”, “counting”, “calculating”, “receiving”, “selecting”, “defining”, “outputting”, “reporting”, “processing”, “tracking”, “collecting, “summing”, “multiplying”, “dividing”, or the like, refer to the action and/or processes of any combination of software, hardware and/or firmware. For example, these terms may refer in some cases to the action and/or processes of a computer or computing system, or similar electronic computing device, that manipulates and/or transforms data represented as physical, such as electronic quantities, within the computing system's registers and/or memories into other data similarly represented as physical quantities within the computing system's memories, registers or other such information storage, transmission or display devices.

Embodiments of the present invention may include apparatuses for performing the operations herein. Each of these apparatuses may be specially constructed for the desired purposes, or may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not necessarily inherently related to any particular computer or other apparatus. Various general purpose systems may in some cases be used with programs in accordance with the teachings herein, or it may in other cases prove convenient to construct a more specialized apparatus to perform the desired method. Possible structures for a variety of these systems will appear from the description below. In addition, embodiments of the present invention are not described with reference to any particular programming language. It will be appreciated that a variety of programming languages may be used to implement the teachings of the inventions as described herein.

Embodiments of the current invention relate to systems and methods of tracking online social interactions. In various instances, tracking may include any of the following inter-alia: ranking user accounts, identifying corresponding user accounts, noting online roles of user accounts and/or calculating the alternative cost of funding a traditional online campaign equivalent in exposure and partiality. In some cases, tracking may be used as part of end to end management of a campaign (e.g. advertisement, marketing, public relations, political, etc.).

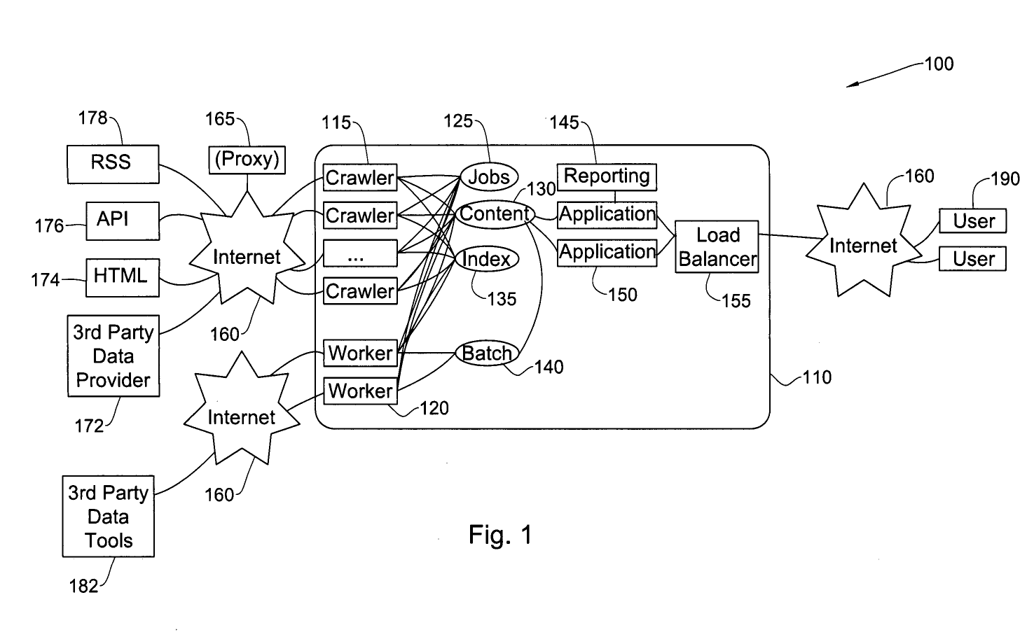

Referring now to the drawings, FIG. 1 illustrates a network 100, including a system 110 for tracking social interactions, according to some embodiments of the invention. System 110 includes any combination of software, hardware and/or firmware capable of performing the operations as defined and explained herein. In the illustrated embodiments, system 110 includes one or more crawlers 115 which collect data from external sources via the Internet 160. For example, an application programming interface “API” 176 may be used to collect data from external sources which are social networks such as Flickr®, YouTube, Facebook, Twitter™, Google Buzz, Delicious, Digg™, etc. In another example, additionally or alternatively, external sources such as Blogs and/or forums can be “scraped” using for example hypertext markeup language “HTML” scraping 174, and/or data can be gathered from blogs and/or forums using really simple syndication “RSS” 178. In another example, additionally or alternatively, data can be collected from external sources which are third party data providers 172, such as search engines (Google™, Collecta, etc), or such as data aggregators (Gnip, etc). Data can be additionally or alternatively collected from external sources using other processes. Optionally a proxy 165 may be used in gathering the data. System 110 also includes a job management module 125 which assigns tasks to the crawlers, so that the crawlers are directed in what to collect. For example, in some embodiments, job management module 125 may include a central job repository in a database which assigns tasks in parallel to crawlers 115. In some cases each task may be defined by type, state, priority and frequency (e.g. one-time or recurrent). In some embodiments, there may be a plurality of servers running the crawlers in order to cope with the large scale of data to be collected.

The invention does not specify the number and type of job management module(s), the number and type of proxy(s), the number and type of crawler(s), the number and type of external source(s) or the number and type of mechanism(s) (e.g. API, RSS scraping, HTML scraping, third party data providers, etc.) used, and in various embodiments the number and type of each may vary and/or be omitted.

Depending on the embodiment, the extent of the data collected may vary. In the illustrated embodiments, the collected data is stored in content database 130. For example content database 130 may in some embodiments include a relational database such as MySQL®, etc, and/or a non-relational database such as Vertica, etc. The invention does not limit the type of content data which is collected and the content data may include any of the following inter-alia: text, links, videos, photos, metadata, geolocation information, timing information, external source of data, device used to create data, or any other appropriate content.

In the illustrated embodiments, the collected data includes inter-alia relationship data. The relationship data is stored in content database 130, for example by storing links. Relationship data may alternatively or additionally be created by system 110 (as will be explained further below) and stored in content database 130.

It is appreciated that various external sources may use different model schemas, APIs etc and therefore it may be challenging to store relationship data. In some embodiments, the various data models are generalized to a superset, i.e. a generic schema able to accommodate the data. Examples of generic schema include inter-alia “activityStrea.ms”, etc. For instance, in some cases the generic schema generalizes the relationships to owner accounts, posts, interactions and counts of ownerless interactions such as views, ratings, etc. In some cases, generalizing to a superset resolves any difficulties in ranking non-uniform sets, for example in a ranking method such as method 400 described below.

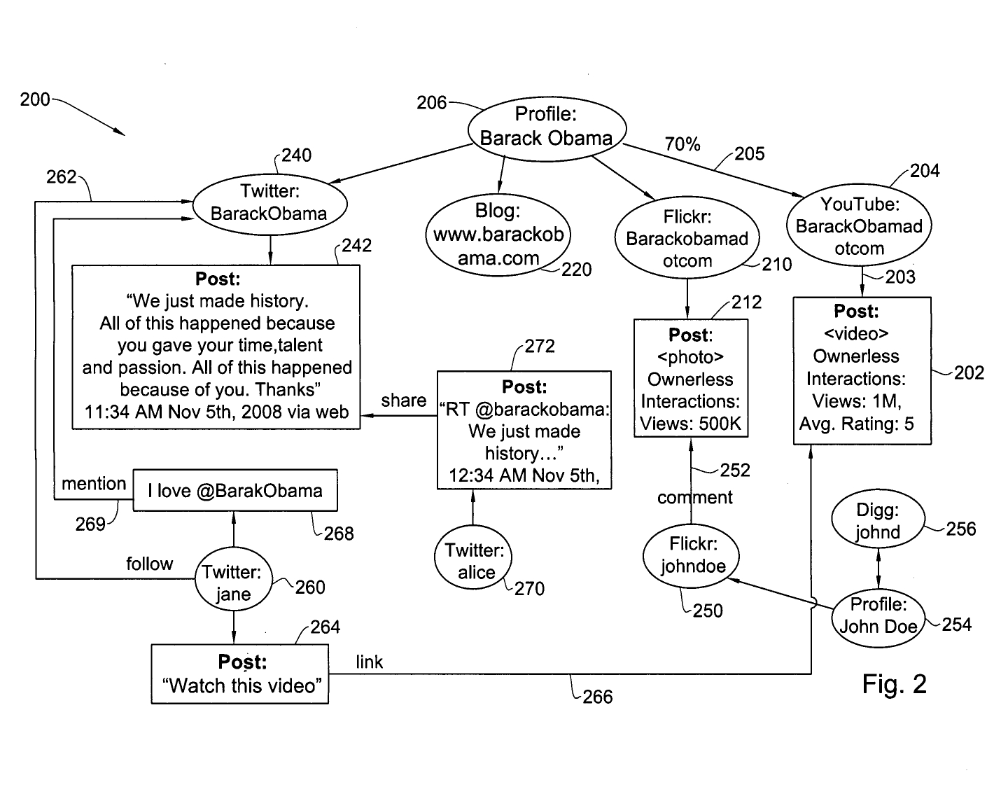

Refer to FIG. 2 which illustrates an example of an interactions graph according to some embodiments of the invention. FIG. 2 will be used to illustrate various aspects of the present invention. It is noted that an interactions graph is presented here as a visual tool to aid in the understanding of the reader, but that system 110 does not necessarily construct nor store such a graph. It is also noted that the number of interactions, user accounts, and profiles included in the interactions graph of FIG. 2 are purposely not many so as to not confuse the reader.

In the illustrated embodiments, a post (AKA item, object, content) such as post 202 is created or initiated by an online user account (AKA user, owner) such as user account 204. Therefore the relationship between user account 204 and post 202 is a relationship of ownership (i.e. user account 204 owns post 202). The relationship is shown in FIG. 2 as a one-direction edge 203. When there are at least two corresponding user accounts, a profile (AKA entity) functions as the identity of the corresponding user accounts. For example, in FIG. 2, user account 204 definitely or with a given probability corresponds to profile (AKA entity) 206, with the relationship shown as a two-direction edge 205. In some cases, the relationship between a user account and a profile may not be definite and therefore the percentage probability of the user account being identical to the entity is associated with the edge, for example here as 70%. The probability assignment will be discussed in further detail below. In embodiments where probabilities are associated with edges, the probability of definite relationships (i.e. 100%) may be associated with the edge or may be inherent if no other probability is associated with the edge. In some embodiments, the edges between profiles and user accounts in an interactions graph may not show the probability.

In the illustrated embodiments, two users accounts 240 and 260 may have a relationship (e.g. friends, family connections, work relations, following you, commented on your item, etc). The edge between two connected user accounts may be one-directional or two-directional depending on the nature of the relationship. The relationship may be explicitly defined by one or both of the user accounts, or may be implicit due to interactions between the two user accounts. For example, if a user account interacted with a post owned by another user account, then the relationship is implicit even if neither user account has explicitly defined a relationship with the other user account. In FIG. 2, for example only user accounts which are explicitly related are connected by an edge. For example, user account 260 follows user account 240, as illustrated by a one-direction edge 262. However, in some embodiments user accounts with an implicit relationship may also be connected by an edge in an interactions graph.

In the illustrated embodiments, a first user account (AKA interacting user account) may have a relationship with a post owned by a second user account by interacting with the post owned by a second user account. Depending on the type of interaction, the continued existence of the interaction may be dependent on the existence of the post or independent of the existence of the post. Examples of interactions which are dependent include comments, likes, favorites, ratings, etc. In these examples, if the post is deleted the interactions will necessarily be deleted. This type of interaction is illustrated as a one-direction edge between the interacting user account and the post that is the focus of the interaction. For example in FIG. 2, user account 250 comments on post 212 which is owned by user account 210. The comment is illustrated as a one-direction edge 252 in FIG. 2. Examples of interactions which are independent include: links, shares (e.g. retweets), etc. In these examples, if the post that is the focus of the interaction is deleted, the interactions will not necessarily be deleted. This type of interaction is shown as a one-direction edge between the post of the interacting user account and the post which is the focus of the interaction. For example user account 260 interacts with post 202 by adding a link to post 202 in post 264 which is owned by user account 260. The link is shown as a one-direction edge 266 in FIG. 2. As another example, user account 270 interacts with post 242 by sharing post 242 through post 272 owned by user account 270. The share is shown as a one-direction edge 274 in FIG. 2. There may also be interactions with a post whose interacting owner account is not known, for example because the information is not publicly available. For example, in FIG. 2, post 212 has been viewed 500 thousand times but since the viewers are not known these interactions are considered ownerless. (It is also possible that the interacting user account may not be known in some instances for comments, ratings, or other interactions and in these instances these types of interactions may therefore be considered ownerless.)

In the illustrated embodiments, a first user account may interact via an owned post directly with a second user account rather than with a post owned by the second user account. An example of this type of direct interaction is a mention. For example interacting user account 260 may post a post 268 which mentions user account 240. The mention is shown as a one-direction edge 269 in FIG. 2.

Referring again to FIG. 1, in the illustrated embodiments, one or more workers 120, for example under the direction of job management module 125, process the collected data in accordance with tracking requirements. In some embodiments the tasks performed by workers 120 may be defined by type, state, priority and frequency (one time or recurrent). Depending on the embodiment, there may be tracking requirements specified by a particular consumer 190 in addition to or instead of tracking requirements which are universally applied regardless of who the consumer is. An example of working module 120 will be presented further below. In some embodiments, in order to cope with the scale of the tracking requirements, workers 120 run on a plurality of servers running in parallel. In some embodiments, workers interface with third party tools 182 via the Internet 160 in order to perform some or all of the processing.

In the illustrated embodiments, reporting module 145 prepares reports in accordance with reporting requirements. Depending on the embodiment, there may be reporting requirements specified by a particular consumer 190 in addition to or instead of reporting requirements which are universally applied regardless of who the consumer 190 is. Depending on the embodiment, report(s) for any particular consumer 190 may be prepared on demand and/or according to a schedule defined by particular consumer 190 and/or defined by system 110. Depending on the embodiment, report(s) for any particular consumer may be provided to particular consumer 190 in any known manner, including inter-alia via email. For example, in one embodiment, a specific report may be generated according to a schedule defined by particular consumer 190 and delivered via email to that consumer.

In some embodiments, in order to cope with a large number of user accounts, content database 130 is clustered into shards. For example, in various embodiments with shards, the partitioning may follow any suitable scheme, including inter-alia directory based partitioning, vertical partitioning, range based partitioning, key/hash based partitioning, etc. For example, in some embodiments with directory based partitioning, each user account and/or profile is assigned a shard number upon creation. In these directory based portioning embodiments, all posts owned by the user account and all interactions originating with the user account are stored in the shard of the user account. In some of these embodiments with directory based partitioning, interactions involving user accounts (or posts thereof) that belong to different shards may be in some cases stored on both shards so as to be accessible when traversing in either direction (e.g. for a given user accounts can retrieve interactions or for a given interaction can retrieve participating user account(s)). In some embodiments, content database 130 is not clustered into shards.

In the illustrated embodiments, the collected data is indexed in an index 135, for example a full text index such Lucene, Solr, etc. In some cases, the index includes all text but not relationship data. For example, in some of these cases the index may include the text associated with user accounts, interactions, profiles and posts, etc. but not the links among various user accounts, interactions, profiles and posts, etc. In some cases, index 135 runs on multiple servers in parallel.

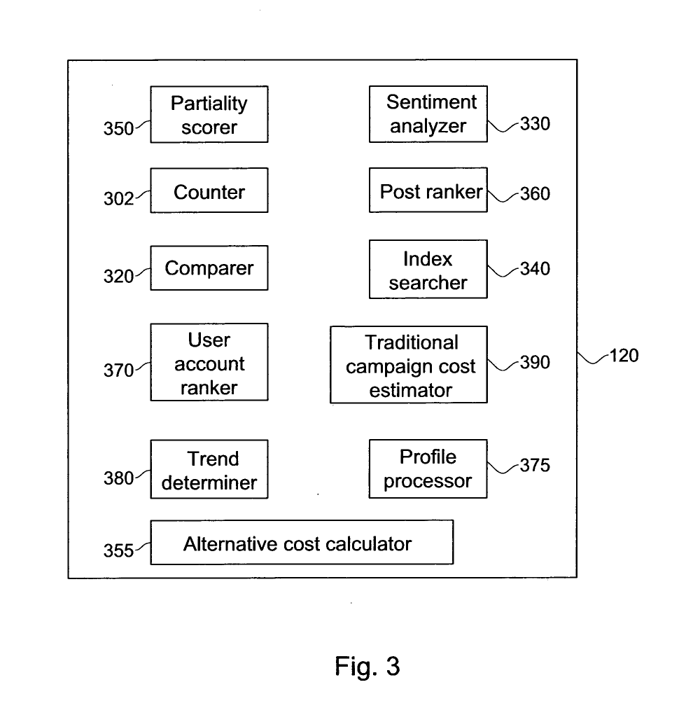

In some embodiments, index 135 may be searched for post(s) by worker 120 (for example by index searcher 340—see FIG. 3). Depending on the embodiment, the search may occur for various purposes. For example, in some embodiments, the search may occur as posts are collected. Continuing with the example, assume that posts are clustered together in clusters. For every newly collected post, index 135 is searched for other similar posts (e.g. “MoreLikeThis”) and index 135 returns a list of other posts including the same frequent terms and a similarity score. If the similarity score is above a predetermined threshold then the new post is linked to the first post (and/or any other posts) in the cluster, thereby building up the cluster. In some cases with clusters, the clustering algorithm is trained using documents belonging to specific categories (and/or market verticals). Therefore, in these cases each cluster can be categorized as belonging to one or more categories and/or market verticals. In another example, additionally or alternatively in some embodiments the search occurs in order to find a subset of posts which fulfill predetermined criteria such as for instance relevance to a defined campaign. Depending on the embodiment, the subset of posts may belong to one or more clusters, categories, and/or market verticals. For instance, in one embodiment of the example, one of the predetermined criteria may specify that the subset of posts belongs to a particular category or categories (or cluster(s), market vertical(s)) whereas in another embodiment of the example the subset of posts are not restricted to any particular category or categories (or cluster(s), market vertical(s)).

In the illustrated embodiments, batch 140 is an additional database used as temporary storage for batch operations. For example, in some cases batch 140 may contain partial information copied from the content database 130 and when batch operations are finished, data may be copied back to content database 130. In some embodiments, batch 140 may be omitted.

In the illustrated embodiments, system 110 also includes one or more applications 150 which allow a consumer 190 to provide and/or receive information regarding social interactions via Internet 160. For example an application may run on a web server and include accessing of stored information. The accessing of the application by consumer 190 is not limited by the invention, and the access may be for example, via any of the following: designated web site, pages on existing websites, desktop and webgadgets and widgets, RSS and email notifications, short message service SMS and extensible messaging and presence protocol XMPP agents (e.g. Twitter), third party integrations, etc. In some embodiments there may be a plurality of slave database servers with replicated data from content database 130 and/or index 135, so as to be able to service a large number of concurrent consumers 190 with reasonable response time. In some cases load balancing of the applications is provided, for example via load balancer 155. The functionality of the application may vary depending on the embodiment. In some embodiments, for example, the application allows end to end campaign management as will be described in more detail below.

It is noted that the invention does not limit the type of consumer 190. The term consumer is used in the broad sense of any person, organization, object, etc. which interacts with application 150 directly or indirectly. Therefore in various embodiments, consumer(s) 190 which interact with application 150 may be human and/or non-human. For example, in some embodiments an API may allow interaction with the application without human intervention.

The invention does not specify the number and type of worker(s), the number and type of content database(s), the number and type of index(es), the number and type of batch(es), the number and type of reporting module(s), the number and type of load balancer(s), or the number and type of application(s) used, and in various embodiments the number and type of each may vary and/or be omitted.

In some embodiments, system 110 may comprise fewer, more and/or different modules than illustrated in FIG. 1. In some embodiments, the functionality of system 110 described herein may be divided differently among the modules shown in FIG. 1. In some embodiments, the functionality of system 110 described herein may be divided into fewer, more and/or different modules than shown in FIG. 1. In some embodiments, system 110 may include additional or less functionality than described herein. In some embodiments, system 110 may be divided into two or more systems, which may possibly be dispersed geographically. For simplicity of description, unless explicitly stated otherwise, the single form of system 110 is used below to include both embodiments with a single system and embodiments with a plurality of systems. Similarly, unless explicitly stated otherwise, the single form of any of the modules shown in FIG. 1 is used below to include both embodiments with one of that module (for example one worker 120) and embodiments with a plurality of those modules (for example a plurality of workers 120). For embodiments with a plurality of systems or a plurality of modules, when reference is made in the discussion below to the system or to a module in the single form (for example worker 120), the reference should be understood to encompass both embodiments where the reference is to one of the systems or to one of the modules and embodiments where the reference is to a plurality of the systems or modules.

It is appreciated that consumers 190 may in some cases not be equivalently interested in all posts, user accounts and/or profiles. It is appreciated that consumers 190 may in some cases be interested in information relating to all user accounts corresponding to a profile, in addition to or instead of separate information relating to each user account. It is appreciated that consumers in some cases may be interested in role(s) played by a user account and/or profile. It is appreciated that consumers may in some cases be interested in quantifying the monetary value of online exposure. For any of these reasons and/or for any other reason, it is appreciated that consumers 190 may in some cases be interested in processing of the collected data in order to extract analysis in accordance with tracking requirements.

FIG. 3 is a block diagram of a worker module 120, according to some embodiments of the present invention. Worker module 120 may be comprised of any combination of software, hardware and/or firmware capable of performing the operations as defined and explained herein, including inter-alia processing of the collected data. In the illustrated embodiments, worker module 120 (aka “worker”) includes one or more counters 302 for keeping track of amounts, one or more comparers 320 for comparing, one or more sentiment analyzers 330 for analyzing sentiments, one or more index searchers 340 for performing searches on index 135, one or more partiality scorers 350 for determining the partiality of a post, one or more alternative cost calculators for calculating the alternative cost of a funding a traditional campaign, one or more post rankers 360 for ranking posts, one or more user account rankers 370 for ranking accounts, one or more profile processors 375 for processing profiles, one or more trend determiners 380 for determining trends, and one or more traditional campaign cost estimators 390 for estimating traditional campaign cost. In embodiments with more than one worker 120, each worker module 120 may be the same or different than the other worker modules. For example, in one case, one worker 120 may include all the counters 302, another worker all the comparers 320 etc, whereas in another case each worker 120 may include the same number of counters 302, comparers 320, etc. In embodiments with more than one worker, workers may possibly be dispersed geographically.

In some embodiments, worker 120 may comprise fewer, more and/or different modules than illustrated in FIG. 3. In some embodiments, the functionality of worker 120 described herein may be divided differently among the modules shown in FIG. 3. In some embodiments, the functionality of worker 120 described herein may be divided into fewer, more and/or different modules than shown in FIG. 3. In some embodiments, worker 120 may include additional or less functionality than described herein. For simplicity of description, unless explicitly stated otherwise, the single form of any module in worker 120 (for example counter 302) is used below to include both embodiments with a single module and embodiments with a plurality of modules. For embodiments with a plurality of modules (for example a plurality of counters 302), when reference is made in the discussion below to the module in the single form (for example counter 302), the reference should be understood to encompass both embodiments where the reference is to one of the modules (for example one of counters 302) and embodiments where the reference is to a plurality of the modules (for example a plurality of counters 302).

It is assumed that one of the tracking requirements is to rank user accounts. It is appreciated that due to the large number of user accounts, from various external sources, it may be advantageous in some cases to rank user accounts. In some embodiments, system 110 is not affiliated with any particular external source or with any user account and therefore the ranking may be considered unbiased. In some embodiments, the ranking algorithm is publicly available and therefore transparent.

In the illustrated embodiments the ranking of a user account includes two phases. In the first phase, ranks of posts are determined by calculating for each a function of the quantity of online interactions with the respective post. In various embodiments, calculation of the function for a given post may include any of the following inter-alia: weighting by type of interaction, weighting by the rank of the interacting user account (if any), dividing the quantity of interactions with a given post by the total quantity of interactions with posts, weighting based on whether or not the interaction is owned or ownerless, and/or taking into account the age of the given post.

In the second phase, ranks of user accounts are determined by calculating for each a function of the ranks of posts that are owned by the respective user account. In some embodiments, the rank of a user account is also a function of the number of direct interactions with the user account. In various cases, therefore, calculation of the function for a given user account may include any of the following inter-alia: summation of the ranks of owned posts, weighting by type of direct interaction, weighting by the rank of the directly interacting user account, dividing the quantity of direct interactions with the given user account by the total quantity of direct interactions that an interacting user had with all user accounts; weighting based on whether the contribution to the given user account rank is from posts or from direct interactions, and/or normalizing the rank of the given user account by a function of the quantity of user accounts and maximum user account rank.

In an optional third phase, ranks of profiles may be determined by calculating for each as a function of the ranks of all user accounts whose probability of corresponding to the respective profile is at least a certain percentage (where the percentage may be 100% or less depending on the embodiment).

In various embodiments, the group of posts which are ranked and/or the group of posts which are considered when determining the ranking of user accounts, may include all available posts, or may include only a subset of posts, for example those fulfilling predetermined criteria. In various embodiments, all direct interactions between user accounts may be taken into account when ranking user accounts, or only direct interactions between owners of posts fulfilling predetermined criteria may be taken into account. In various embodiments, the user accounts which are ranked may include all available user accounts or only a subset of user accounts, for example those fulfilling predetermined criteria. For example in one embodiment, only posts belonging to a user account of interest may be ranked, in order to be able to subsequently rank the user account, or only a subset of posts belonging to a user account of interest which fulfill predetermined criteria may be ranked in order to be able to subsequently rank the user account.

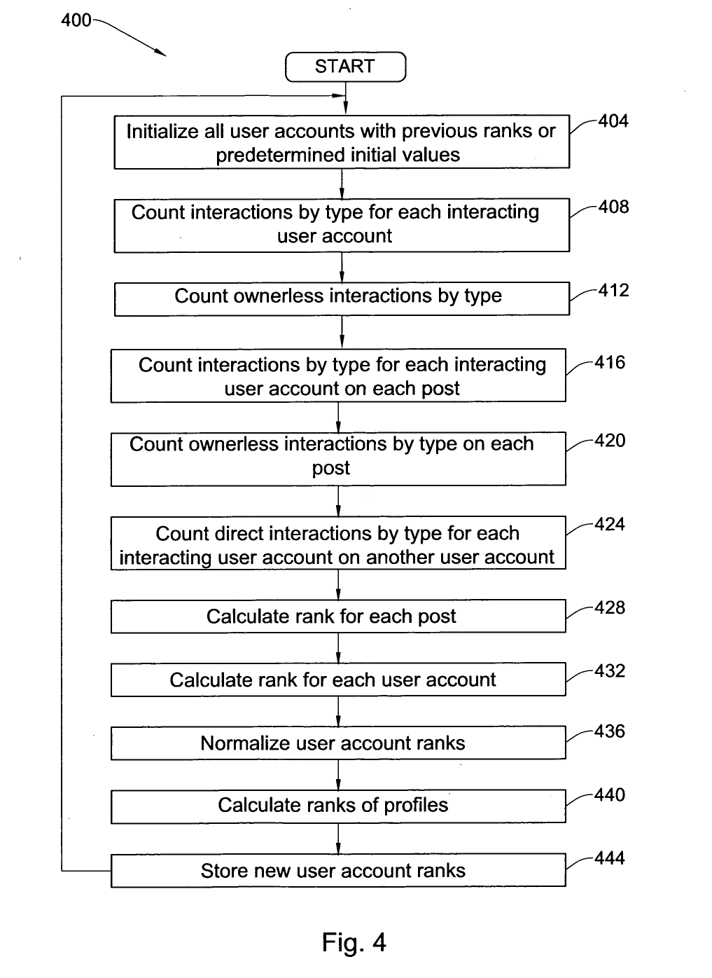

One example of a method of ranking user accounts will now be described with reference to FIG. 4. This example is provided to aid in the understanding of the reader and should not be construed as restricting the invention. To further illustrate stage 436 to the reader, some numerical calculations of equation 2 are now provided. It should be evident that these values are just for the sake of providing numerical calculations and are not binding.

FIG. 4 is a flowchart of a method 400 of ranking user accounts, according to some embodiments of the present invention. In some cases, method 400 may include fewer, more and/or different stages than illustrated in FIG. 4, the stages may be executed in a different order than shown in FIG. 4, and/or stages that are illustrated as being executed sequentially may be executed in parallel.

In the illustrated embodiments in stage 404 the rank of each user account (AR_{owner}) is initialized to the previous rank thereof (from previous iteration) or to a predetermined initial value if no rank exists. For example, referring to FIG. 2 and assuming that this is the first time method 400 is performed, and that all user accounts in FIG. 2 are being ranked, user accounts 204, 210, 220, 240, 250, 256, 260 and 270 are initialized to a predetermined initial value, say 1. Stage 404 can be performed for instance by user account ranker 370.

In the illustrated embodiments in stage 408, the total number of (owned) interactions by type executed by each user account n_{type}_{_{owner}} is counted. Stage 408 may be performed for instance by counter 302. For example, in the interactions graph of FIG. 2 and assuming all posts are part of the group, user accounts 250, 260 and 270 each performed one interaction on posts, each of a different type, user account 260 performs one direct interaction on another user account, and the remaining user accounts performed no interactions on posts nor direct interactions.

In another example, assume that only the subset of posts that reflect “making history” (relating to the election of Barak Obama) such as post 242 fulfill predetermined criteria and are therefore part of the group, that the video in post 202 relates to “making history” and therefore fulfills predetermined criteria and is part of the subset but the photo in post 212 is not associated with “making history” and therefore does not fulfill predetermined criteria and is not part of the subset. In this case, user account 270 performed one interaction on posts in the subset of type “share”, user account 260 performed one interaction on posts in the subset of type “link”, and the remaining user accounts performed no interactions on posts in the subset.

In the illustrated embodiments in stage 412 the total number of ownerless interactions on posts by type n_{type}_{_{ownerless}} is counted. Stage 412 may be performed, for instance by counter 302. For example, assuming all posts in FIG. 2 are part of the group, post 202 had 1 million views and post 212 had 500 thousand views so the total number of ownerless views on posts was 1.5 million. It is assumed that the user accounts who rated post 202 are unknown and therefore the ratings are ownerless. For example, in some cases the ratings may follow the 5 star rating system employed for example by YouTube or the Thumbs-up/Thumbs-down rating procedure which track the total number of rating votes, the sum of all votes, and the average rating. Here it is assumed that there is an average rating of 5, and that the number of ownerless ratings is ten thousand (i.e. ten thousand votes were cast).

In another example, it is again assumed that only ownerless interactions are considered which are on posts in the subset relating to “making history” (only this subset being in the group). It is again assumed that post 202 relates to making history and is therefore part of the subset but post 212 does not. In this example total number of ownerless views would reflect only those on post 202, e.g. 1 million.

In the illustrated embodiments in stage 416 the number of interactions on a given post by type executed by each user account n_{type}_{_{owner}} is counted. For instance, stage 416 may be performed by counter 302. For example, referring to FIG. 2, post 242 has one interaction of type share by user account 270, post 202 has one interaction of type link by user account 260, and post 212 has one interact account 250. There were no interactions on posts 268 and 270. Among the posts with at least one interaction if it is assumed that all posts 242, 202, and 212 are in the group then the number of interactions is counted for each of posts 242, 202, and 212.

In another example, however only posts 242 and 202 are among the subset of posts with at least one interaction that are assumed to fulfill predetermined criteria (relating to “making history”) and therefore the number of owned interactions for post 212 may not be counted or the number may be counted and ignored.

In the illustrated embodiments in stage 420, the number of ownerless interaction on a given post by type

$${n}_{{obj}_{{type}_{ownerless}}}$$

is counted. For instance stage 420 may be performed by counter 302. For example referring to FIG. 2, post 202 has 1 million views and post 212 has 500 thousand views. Post 202 also has ten thousand ownerless ratings. No other posts were the focus of ownerless interactions. As another example, if post 212 is assumed to not fulfill predetermined criteria (relating to “making history”) then the number of ownerless interactions for post 212 may not be counted or the number may be counted and ignored.

In the illustrated embodiments in stage 424 the number of direct interactions by type executed by each user account on another user account

$${n}_{{owner}_{{type}_{owner}}^{′}}$$

is counted (in order to differentiate in the description of owner method 400 the interacting user account is written without a prime and the user account which is the focus of the interaction is written with a prime). For instance stage 420 may be performed by counter 302. For example, in FIG. 2, interacting user account 260 provides one mention of user account 240. In another example where only a subset of posts are evaluated, then in some cases only interactions between owners of posts in the subset are evaluated. In FIG. 2 it is assumed that posts 242 and 264 are in the subset since both relate to “making history” and therefore the direct interaction by user account 260 on user account 240 is counted.

In the illustrated embodiments in stage 428, the ranks for posts are calculated, for instance, by post ranker 360. In some embodiments post ranker 360 uses the map function in the Hadoop map/reduce framework in of these embodiments, several map/reduce job flows are executed one after another, where each map phase uses the previous reduce phase as input thereof.

In one example, referring to FIG. 2 if all posts are in the group then the ranks for all posts are calculated. In another example if only posts in the subset relating to “making history” are considered, then post 212 and 268 which are assumed to not relate to making history are not ranked.

A sample equation for calculating the rank of each post AR_{obj} is provided by equation 1:

$${AR}_{obj} = ( {\sum }_{owner} {\sum }_{type} \frac{{m}_{type} \cdot {n}_{{obj}_{{type}_{owner}}} \cdot {AR}_{owner}}{{n}_{{type}_{owner}}} + k {\sum }_{type} \frac{{m}_{type} \cdot {n}_{{obj}_{{type}_{ownerless}}}}{{n}_{{type}_{ownerless}}} ) \cdot {e}^{- {λ age}_{obj}} \qquad ( eqn 1 )$$

where k is a constant used to adjust the weight between interactions with a known origin and ownerless interactions; m_{type} is a constant used to adjust the weight of different types of interactions, age is the number of days between the date the post was posted and the current date, and λ is a decay-exponent constant, for example close to zero.

To further illustrate stage 428 to the reader, some numerical calculations of equation 1 are now provided. It should be evident that these values are just for the sake of providing numerical calculations and are not binding.

For example, assume mₛₕₐᵣₑ is 4, m_{comment} is 3, mₗᵢₙₖ is 2, m_{view} is 1, and m_{rating} is the average rating divided by a predetermined rating of 2.5. Further assume that k is 1, λ, is 0.01 and that posts 242 and 272 are 50 days old, post 212 is 30 days old, post 264 is 5 days old and posts 202 and 264 are 40 days old. It is further assumed that the previous ranks of user accounts 204 and 210 were 12, the previous rank of user account 240 was 15, the previous rank of user account 220 was 1, the previous rank of user account 260 was 5, the previous rank of user account 270 was 3, the previous rank of user account 250 was 6, and the previous rank of user account 256 was 1.

Beginning with post 242, post 242 is the focus of one interaction by user account 270 (rank 3) with mₛₕₐᵣₑ of 4 out of a total of one share interaction executed by user account 270 on any posts. There are no ownerless in age of the post is 50 days. Therefore the rank of the post is

$$( \frac{4 \times 1 \times 3}{1} + 0 ) \cdot {e}^{- 0.01 \times 50} = 7.3$$

Post 272 is the focus of no interactions and therefore has rank of 0. Post 268 is the focus of no interactions and therefore has rank of 0. Post 264 is the focus of no interactions and therefore has rank of 0.

Post 202 (age 40 days) is the focus of one interaction by user account 260 (rank of 5) with mₗᵢₙₖ of 2, out of a total of one link interactions performed by user account 260 on any posts. Post 202 also is the focus of 1 million ownerless views with m_{view}. of 1, and the focus of ten thousand ratings with m_{rating} of 5/2.5=2. The total number of ownerless views on all posts is 1.5 million (total of views of post 202 and 212). The total number of ownerless ratings is ten thousand. k is assumed to equal 1. Therefore the rank of the post is

$$( \frac{2 \times 1 \times 5}{1} + 1 \times ( \frac{1 \times 1 million}{1.5 million} + \frac{2 \times 10 thousand}{10 thousand} ) ) \cdot {e}^{- 0.01 \times 40} = 8.5$$

Post 212 (age 30 days) is the focus of one interaction by user account 250 (rank of 6) with m_{comment} of 3 out of a total of one comment by user account 250 on any posts. Post 212 is the focus also of 500 thousand ownerless views out of a total number of ownerless views of 1.5 million with of 1. k is assumed to be 1. Therefore the rank of the post is

$$\frac{3 \times 1 \times 6}{1} + 1 \times \frac{1 \times 500 thousand}{1.5 million} \cdot {e}^{- 0.01 \times 30} = 13.6$$

If only the subset of posts which relate to “making history” are considered (e.g. posts 264, 272, 242, and 202), then the ranks of posts 264, post 272 and post 242 remain unchanged, but the rank of 202 would change because the total number of ownerless views on posts relating to making history equals 1 million (views on 202) rather than 1.5 million (views on 202 and 212). The rank of 202 would be increased to 8.7.

It should be evident that equation 1 is only one example of an equation which may be used to rank posts and that other equations which rank posts may be used in some embodiments.

In the illustrated embodiments in stage 432, ranks for user accounts are calculated. Stage 432 may be executed for instance by user account ranker 370. In some embodiments user account ranker 370 uses the reduce function in the Hadoop map/reduce framework in performing stage 432. In some of these embodiments, several map/reduce job flows are executed one after the other, where each map phase uses the previous reduce phase as input thereof.

A sample calculation of user account ranks is given by equation 2:

$${AR}_{{owner}^{′}}^{′} = l {\sum }_{owner} {\sum }_{type} \frac{{m}_{type} \cdot {n}_{{owner}_{{type}_{owner}}^{′}} \cdot {AR}_{owner}}{{n}_{{type}_{owner}}} + {\sum }_{object} {AR}_{{obj}_{{owner}^{′}}} \qquad ( equation 2 )$$

where l is a constant used to adjust the weight between direct interactions and interactions with posts.

To further illustrate stage 432 to the reader, some numerical calculations of equation 2 are now provided. It should be evident that these values are just for the sake of providing numerical calculations and are not binding. It is assumed in the numerical examples below that l=1 and mₘₑₙₜᵢₒₙ is 3.

User account 240 was the focus of one direct interaction mention from user account 260 (rank of 5) with mₘₑₙₜᵢₒₙ of 3 out of a total of one mention performed by user account 260. User account 240 owns one post 242 with rank of 7.3. Therefore the rank of user account 240 is

$$1 \cdot \frac{3 \cdot 1 \cdot 5}{1} + 7.3 = 22.3$$

User account 220 owns no posts and was not the focus of any direct interactions and therefore the rank is 0. User account 210 owns one post 212 with rank of 13.6 (but was not the focus of any direct interactions) and therefore the rank of user account 210 is 13.6. User account 204 owns one post 202 with rank of 8.5 (but was not the focus of any direct interactions) and therefore the rank of user account 204 is 8.5. User account 256 owns no posts and was not the focus of any direct interactions and therefore the rank of user account 256 is 0. User account 250 owns no posts and was not the focus of any direct interactions and therefore the rank is 0. User account 270 owns post 272 which has 0 rank (and was not the focus of any direct interactions) and therefore user account 270 also has rank 0. User account 260 owns two posts 268 and 264 which both have tank of 0 (and was not the focus of any direct interactions) and therefore user account 260 has rank of 0.

If only posts relating to “making history” and direct interactions between owners of posts relating to “making history are taken into account” then all user account ranks remain unchanged except for the ranks of user accounts 210 and 204. Post 212 does not relate to making history and therefore is ignored. The rank of user account 210 which owns one post 212 and was not the focus of any direct interactions would therefore be 0. The rank of 202 would be increased to 8.7 and therefore the rank of user account 204 which owns post 202 would also be increased to 8.7.

It should be evident that equation 2 is just one example of an equation for ranking user accounts and that other equations for ranking user accounts may be used instead in some embodiments.

In the illustrated embodiments in stage 436, the ranks of the user accounts may be normalized. Stage 436 may be performed for example by user account ranker 370. For example one normalization function is presented here as equation 3.

$${AR}_{{owner}^{′}} ( normalized ) = \frac{{AR}_{{owner}^{′}}^{′} \cdot {n}_{{owners}^{′}}}{max ( {AR}_{{owner}^{′}}^{′} )} \qquad ( equation 3 )$$

where n_{owners'} is the number of user accounts and max(AR′_{owner′}) is the maximum user account rank from stage 432.

To further illustrate stage 436 to the reader, some numerical calculations of equation 3 are now provided. It should be evident that these values are just for the sake of providing numerical calculations and are not binding.

For example, in FIG. 2 there are eight user accounts, and from stage 432 the maximum rank was 22.3. The normalized ranks would therefore be zero for user accounts 220, 250, 256, 260 and 270. For user account 240 the normalized rank would equal 22.3*8/22.3=8. For user account 210 the normalized rank would equal 13.6*8/22.3=4.9. For user account 204, the normalized rank would equal 8.5*8/22.3=3.0. If the ranks of user account 210 and 204 are instead the ranks relating to “making history” then the normalized rank of 210 would be 0 and the normalized rank of 204 would be 8.7*8/22.3=3.1.

It should be evident that equation 3 is just one example of an equation for normalization and that other equations for normalization may be used instead in some embodiments. In other embodiments normalization stage 436 may be omitted.

In the illustrated embodiments in stage 440 profiles are ranked as a function of those user accounts definitely corresponding (e.g. with 100% probability) with the profiles or whose probability of corresponding with the profiles is above a predetermined percentage which may in some cases be less than 100%. Stage 440 may be executed for instance by profile processor 375. For example, the rank of a profile may equal the sum of the un-normalized or normalized ranks of all corresponding user accounts.

For example, assume that profile 206 corresponds to user accounts 240, 220, 210, and 204, and that profile 254 corresponds to user accounts 256 and 250. Assuming that the rank of a profile equals the sum of normalized ranks of corresponding user accounts, the rank of profile 206 would equal the sum of the normalized ranks of user accounts 240, 220, 210, and 204 and the rank of profile 254 would equal the sum of the ranks of user accounts 256 and 250.

In some embodiments, other functions may be used for calculating the profile rank. In some embodiments, stage 440 may be omitted.

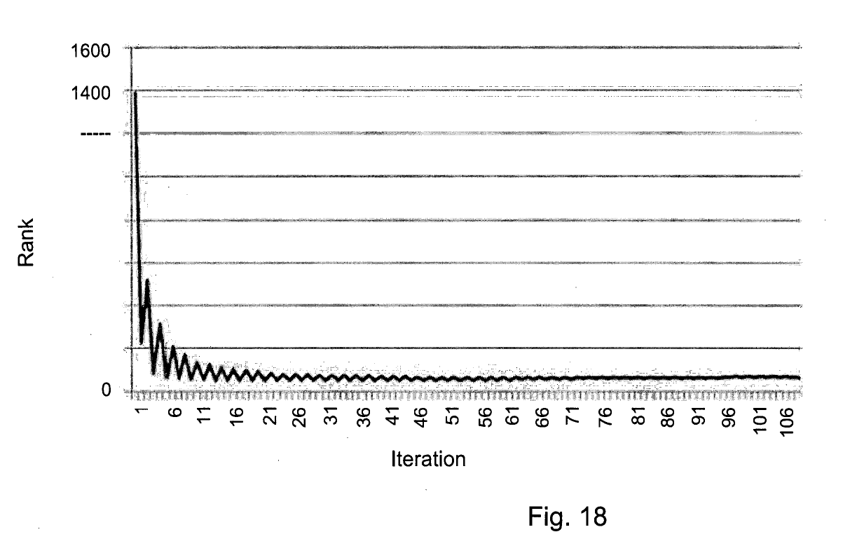

In the illustrated embodiments in stage 444, the new user account ranks (normalized and/or un-normalized) are saved and optionally the new ranks of the profiles are stored. In some embodiments, stage 444 may be omitted. Method 400 then iterates beginning with stage 404. In some embodiments, each new iteration brings user account ranks closer to convergence. Refer for example to FIG. 18 which shows the rank of one user account converging with each iteration, according to some embodiments of the invention. It should be noted that the convergence illustrated in FIG. 18 is not necessarily representative of convergence in all embodiments.

In various embodiments, none, any, or all of the following may be applied to user accounts and/or profiles after ranking: filtering, selecting, and/or sorting.

In some embodiments where all posts and user accounts were ranked (and not only those relating to a subset), a filtering process may in some cases then be performed to only choose those user accounts which fulfill predetermined criteria. Alternatively, in some embodiments where only a subset of posts and/or user accounts were ranked, a further filtering process may in some cases then be performed to only choose those user accounts which fulfill further predetermined criteria. For example, assume all user accounts in FIG. 2 were ranked. However, only a subset of user accounts, those relating to “making history”, are of interest to a given consumer 190. Depending on the embodiment, the subset may include those user accounts which own a minimum number of posts relating to making history. Alternatively or additionally the subset may include those user accounts which interacted a minimum number of times with posts and/or other user accounts relating to “making history”. For instance, assume the subset includes only those user accounts owning at least one post relating to making history, namely accounts 240, 270, 260, and 204 in this example. Therefore the ranks of all other user accounts may in some cases be ignored and filtered out.

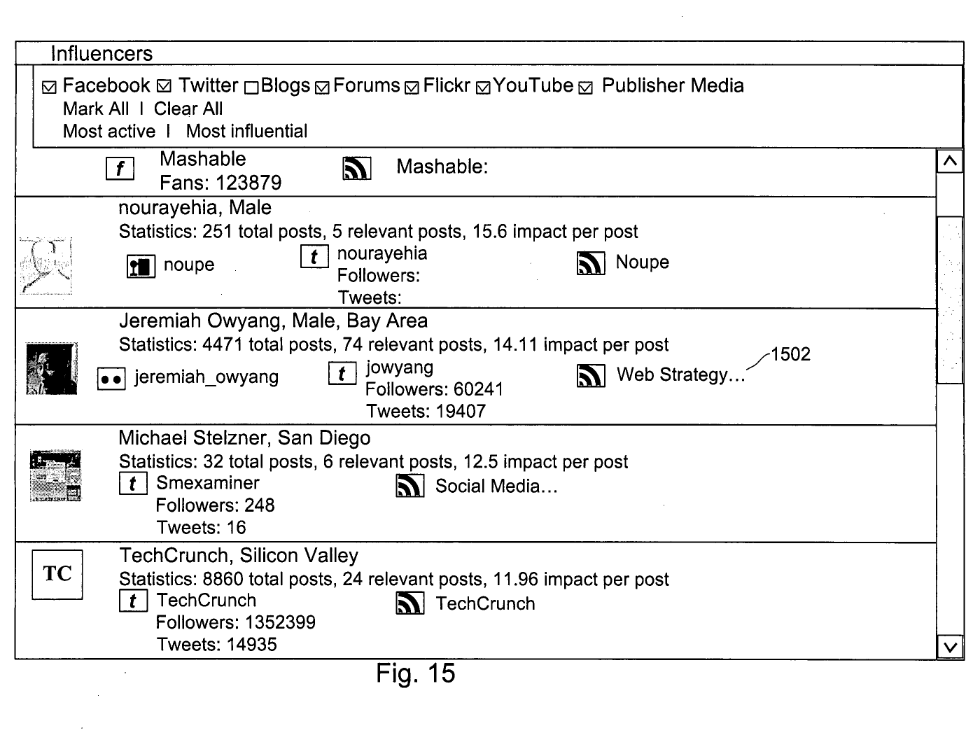

In some embodiments, the ranks may be presented to consumers 190, and/or may be used internally by system 110. In some embodiments, the presentation of the user accounts and/or profiles to the consumer reflects the rank in any one of various ways including inter-alia: explicit presentation of the rank, selection of user accounts/profiles to be presented based on rank, and/or sorting the user accounts/profiles to be presented based on the rank. For example, the user account ranks and/or profile ranks may in some cases be used to determine the order of display with higher ranked user accounts/profiles outputted in a more prominent position than lower ranked user accounts/profiles. In another example, additionally or alternatively the user accounts/profiles ranks may in some cases be used as the sole or one of the factors to determine whether or not those user accounts/profiles are selected to be provided to consumers 190. Continuing with the example, in some of these cases only user accounts/profiles with rank above a predetermined threshold, and/or the in the top predefined percentile of ranks are selected to be provided. In embodiments where the ranking is used internally, the ranking may serve as a primary selection and/or sorting factor, a secondary selection and/or sorting factor, or an even less important selection/sorting factor. See also below description with reference to FIG. 15.

In some embodiments, various user accounts may provide one or more functions (i.e. play one or more roles) in the online environment. For example roles may include inter-alia:
i. Contributor—posts items that become interesting/popular
ii. Spotter—early discoverer of items that become interesting/popular
iii. Connector—people ask Connectors questions and they refer them to Mavens. Connectors are people who, early on, share the information among their peers
iv. Maven—people being referred to by Connectors for help or information
v. Salesman—posts links to interesting/upcoming items. Links and discusses upcoming topics and spreads them to the mainstream
vi. Cataloger—adds meaningful tags and information to existing items
vii. Commenter—discusses interesting/upcoming items and provokes further discussion. Engages in conversations, usually experts in the field
viii. Filter—marks interesting/upcoming items as favorites and acts as a filter for other people
ix. Spammer—repeatedly posts the same information on multiple items
x. Attracts views—posts items that attract views
xi. Engaging—posts items that attract comments

In some embodiments, it may be useful to determine which role or roles various user accounts play. In some of these embodiments, it is determined which role or roles various user accounts play over time and therefore as posts and interactions are collected, the role or roles played by various user accounts via posts and/or interactions is/are noted. For example, measurements (AKA metrics) for roles may be kept so that user accounts can be distinguished from one another according to how the user accounts perform in the various roles.

In some of these embodiments, it is alternatively or additionally determined which role various user accounts play with respect to a trend, and therefore the time point that a trend begins is determined by worker 120, for example by trend determiner 380. A time period before the trend begins is selected and/or a time period after the trend begins is selected. The role or roles played by various user accounts via posts and/or interactions in the time period is/are noted. For example, measurements (AKA metrics) for roles may be kept so that user accounts can be distinguished from one another according to how the user accounts perform in the various roles.

Depending on the embodiment the notation of roles may or may not reflect the extent of the roles. For example, if not based on the extent then worker 120, for example counter 302, may reflect the notation but may be indifferent to the extent, whereas if based on the extent then worker 120, for example counter 302, may reflect the extent by the metric value.

In some cases, the noted roles (over time and/or with respect to a trend) can be used as a basis for selecting user accounts. For instance user accounts which were noted as contributors (or catalogers, etc) may be selected. In various cases where the noted roles are a basis for selecting user accounts, selection of user accounts may or may not be based on the extent of the roles. For example, assuming the extent of roles is expressed by role metrics, a first user account may have a high metric for the contributor role and a low metric for a commenter role whereas a second user account may have a low metric for the contributor role and a high metric for the commenter role. Therefore, if a particular consumer 190 is interested in user accounts which are contributors, the consumer in this example may be more interested in the first user account, whereas if the particular consumer 190 is instead interested in commenters, then the consumer in this example may be more interested in the second user account.

In various embodiments, the group of posts which are considered and/or the collection of interactions which are considered may include all available posts and interactions (bound or not bound by given time period(s)), or may include only a subset of posts, for example those fulfilling predetermined criteria (bound or not bound by given time period(s)), and associated interactions.

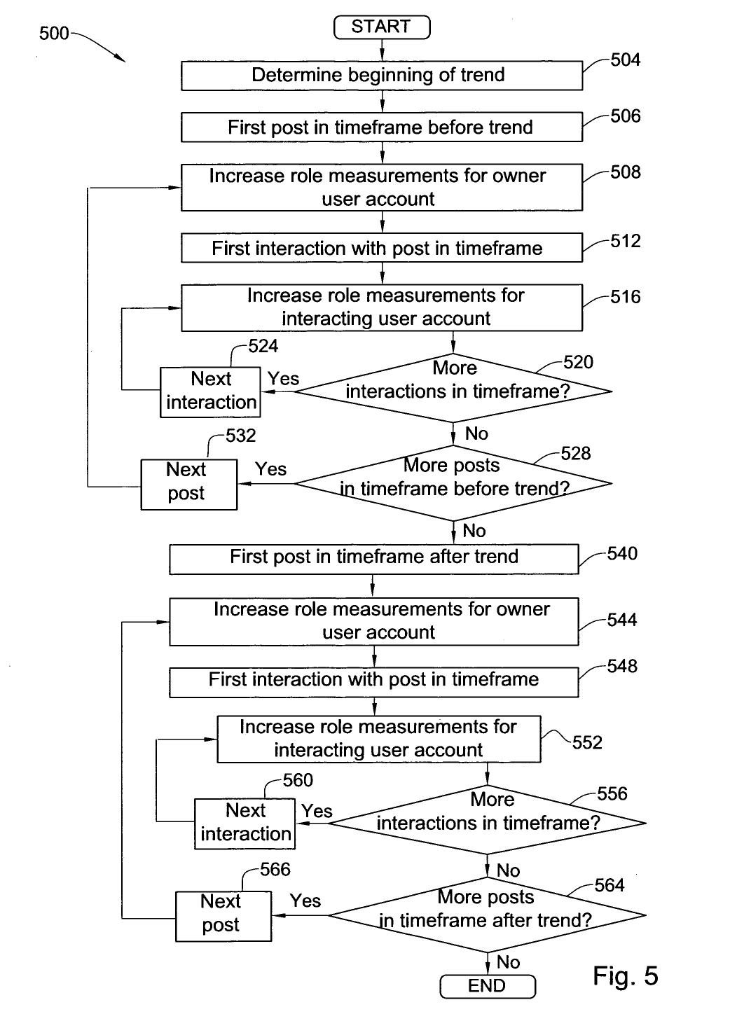

An example of a method of keeping track of roles played by user accounts with respect to a trend will now be described with reference to FIG. 5. This example is provided to aid in the understanding of the reader and should not be construed as restricting the invention. Furthermore, the example is described with reference to the interactions graph of FIG. 2, in order to aid in the understanding of the reader, but the ranking of user accounts is not restricted to social interactions as illustrated in FIG. 2.

FIG. 5 is a flowchart of a method 500 of keeping track of roles played by user accounts with respect to a trend, according to some embodiments of the present invention. In some cases, method 500 may include fewer, more and/or different stages than illustrated in FIG. 5, the stages may be executed in a different order than shown in FIG. 5, and/or stages that are illustrated as being executed sequentially may be executed in parallel.

In the illustrated embodiments in stage 504, the beginning of a trend is detected. Stage 504 can be performed for example by trend determiner 380.

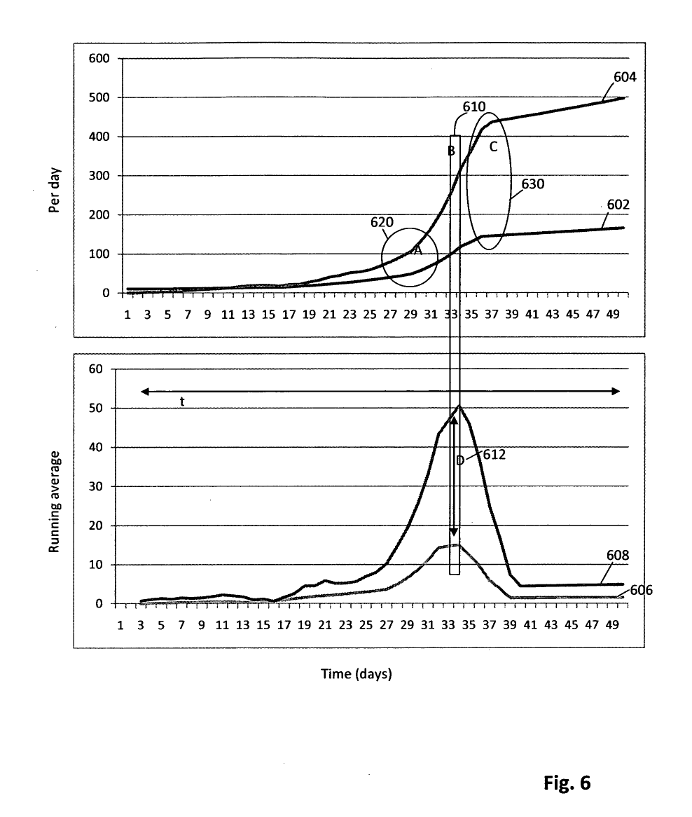

For example, refer to FIG. 6 which shows over a given period of time graphs of the number of posts and interactions per day and graphs of the running average deltas of posts and interactions, according to some embodiments of the present invention. Curve 602 represents the number of posts per day and the curve 604 represents the number of interactions with those posts per day. Curve 606 represents the running average delta for posts and curve 608 represents the running average delta for interactions. For example, the running average delta may be calculated by calculating the difference between the current value and the previous value and then taking a running average of the differences.

In some embodiments, the posts graphed in FIG. 6 belong to a subset of posts collected by system 110 which fulfill certain criteria over the time illustrated. In other embodiments, the posts graphed in FIG. 6 represent all of the posts collected by system 110 over the time illustrated.

In the illustrated embodiments, when looking for local maximums in the running average delta curves in a variable time window, it can be seen that at timepoint B 610, running average delta curves 606 and 608 reach maximums (peaks). The variable time window is not limited by the invention, and depending on the embodiment may be a few days, a week, etc. After timepoint B 610, the increase in posts and interactions per day slows down. In some embodiments, if the difference D 612 between the interactions running average delta curve and the posts running average delta curve is above a predetermined threshold then it is assumed that timepoint B 610 represents the beginning of a trend. In these embodiments, if the difference D 610 is below a predetermined threshold then it is assumed that timepoint B 610 is not the beginning of a trend. For example, it may be assumed that if there are too many posts in relation to the number of interactions and that therefore the posts have not had sufficient online impact to mark a trend. In other embodiments, there may not be a comparison to a threshold and a trend may be detected for peaks regardless of the value for difference D 610.

In other embodiments, alternatively or additionally the beginning of a trend may be detected based on input from a consumer 190 who inputs the timepoint B, stating that at this time the trend began.

In the illustrated embodiments, in the remaining stages of method 500, role metrics are determined for a predetermined period (AKA timeframe) before the beginning of the trend (in FIG. 6, period A 620) and for a predetermined period (AKA timeframe) after the beginning of the trend (in FIG. 6, period C 630). The duration of the predetermined period before the beginning of the trend and the duration of the predetermined period after the beginning of the trend may vary depending on the embodiment. The remaining stages of method 500 may be executed for instance by counter 302 and/or post ranker 360.

For example, in some embodiments, in order to measure performance in various roles, a specific counter 302 is maintained for each user account and for each role that is tracked by system 110. For instance, the counter can be defined by <user account, <role, rank>>. Alternatively or additionally, in some embodiments of this example a specific counter may be maintained for each subset of posts. For instance the counter can be defined by <user account, <subset, <role, rank>>>.

In the illustrated embodiment, for each post in the timeframe before the beginning of the trend, beginning with a first post in stage 508 one or more role performance measurements are increased for the user account of the owner of the post, for instance by increasing the count in the corresponding counter(s). For example, the counter associated with the contributor role may be increased by the rank of the post (AR_{obj}), where the age is assumed to be 1 day. The reader is referred to method 400 above for an example of a procedure for ranking a post. As another example, additionally or alternatively, if the post had ownerless views, the counter associated with “attracting views” role may be increased by the rank of the post (AR_{obj}), where the age is assumed to be 1 day. As another example, additionally or alternatively, if the post had ownerless ratings the counter associated with “engaging role” may be increased by the rank of the post (AR_{obj}), where the age is assumed to be 1 day.

Next in the illustrated embodiments, each interaction on the currently considered post within the timeframe before the beginning of the trend is considered. Beginning with a first interaction, in stage 516, one or more role performance measurements are increased for the interacting user account, for instance by increasing the count in the corresponding counter(s). For example, the counter associated with connector role may be increased by the rank of the post (AR_{obj}), where the age is assumed to be 1 day, if the interaction was a share or link. As another example, if the interaction including marking as a favorite, the counter associated with spotter role may be increased by the rank of the post (AR_{obj}), where the age is assumed to be 1 day. As another example, if the interaction included a comment, the counter associated with maven role may be increased by the rank of the post (AR_{obj}), where the age is assumed to be 1 day. As another example, if the interaction included adding a tag, the counter associated with cataloger may be increased by the rank of the post (AR_{obj}), where the age is assumed to be 1 day.

It should be evident that the invention is not bound by the described values added to the role measurements for posts and for various types of interactions, and that in some embodiments the values added may be more or less than described above (or may be insignificant if the extent of the roles is not important). It should also be evident that the invention is not bound by the described specific roles for which measurement values are increased for posts and/or interactions and that in some embodiments more, less, and/or different roles may have measurement values increased additionally or alternatively to the roles described above.

If there are more interactions on the currently considered post (yes to stage 520) within the timeframe before the beginning of the trend, then stage 516 is repeated for a next interaction. Once all interactions on the currently considered post within the timeframe before the beginning of the trend have been considered (no to stage 520), then if there are remaining posts in the timeframe before the trend began (yes to stage 528) then stages 508 to 528 are repeated for the next post. Once all posts from the timeframe before the trend began have been processed (no to stage 528) then method 500 continues to stage 540.

To further illustrate stages 504 to 532 to the reader, some numerical calculations are now presented. It should be evident that these values are just for the sake of providing numerical calculations and are not binding.

Referring again to FIG. 2, assume that posts 242 and 272 occurred in the timeframe before the beginning of the trend. Therefore user account 240 which owns post 242 has contributor role counter increased by the rank of the post (assuming age of 1 day). As assumed above, post 242 is the focus of one interaction in the timeframe by user account 270 (rank 3) with mₛₕₐᵣₑ of 4 out of a total of one share interaction executed by user account 270 on any posts. Therefore the rank of the post using equation 1 is computed to be

$$( \frac{4 \times 1 \times 3}{1} + 0 ) \cdot {e}^{- 0.01 \times 1} = 11.9 .$$

Similarly user account 270 which owns post 272 has contributor role counter increased by the rank of post 272, but since the rank of post 272 is zero the counter is not affected. However, since user account 270 shared post 242 (via post 272), during the predetermined time frame, the connector role counter for user account 270 is increased by the rank of post 242, where the rank of the post is 11.9 as calculated above.

In the illustrated embodiments, for each post in the timeframe after the beginning of the trend, beginning with a first post in stage 540 one or more role performance measurements are increased for the user account of the owner of the post, for instance by increasing the count in the corresponding counter(s). For example, the counter associated with the salesman role may be increased by the rank of the post (AR_{obj}), where the age is assumed to be the date of the post minus the date of the beginning of the trend (recall that the date of the beginning of the trend is represented by date B 610). As another example, additionally or alternatively, if the post had ownerless views the counter associated with “attracting views” role may be increased by the rank of the post (AR_{obj}), where the age is assumed to be the time passed from time B 610 when the trend began until the time of the views. As another example, additionally or alternatively, if the post had ownerless ratings the counter associated with “engaging role” may be increased by rank of the post (AR_{obj}), where the age is assumed to be the time passed from time B 610 when the trend began until the time of the ratings.

Next, in the illustrated embodiments, each interaction on the currently considered post within the timeframe after the beginning of the trend is considered. Beginning with a first interaction, in stage 544, one or more role performance measurements are increased for the interacting user account, for instance by increasing the count in the corresponding counter(s). For example, the counter associated with salesman role may be increased by the rank of the post (AR_{obj}), where the age is assumed to be date of the interaction minus the date of the beginning of the trend, if the interaction was a share or link. As another example, if the interaction including marking as a favorite, the counter associated with filter role may be increased by the rank of the post (AR_{obj}); where the age of the post is assumed to be the date of the interaction minus the date of the beginning of the trend. As another example, if the interaction included a comment, the counter associated with commenter role may be increased by the rank of the post (AR_{obj}), where the age of the post is assumed to be the date of the interaction minus the date of the beginning of the trend. As another example, if the interaction included adding a tag, the counter associated with cataloger may be increased by the rank of the post (AR_{obj}), where the age of the post is assumed to be the date of the interaction minus the date of the beginning of the trend.

It should be evident that the invention is not bound by the described values added to the role measurements for posts and for various types of interactions, and that in some embodiments the values added may be more or less than described above (or may be insignificant if the extent of the roles is not important). It should also be evident that the invention is not bound by the described specific roles for which measurement values are increased for posts and/or interactions and that in some embodiments more, less, and/or different roles may have measurement values increased additionally or alternatively to the roles described above.

If there are more interactions on the currently considered post (yes to stage 556) within the timeframe after the beginning of the trend, then stage 552 is repeated for a next interaction. Once all interactions on the currently considered post within the timeframe after the beginning of the trend have been considered (no to stage 556), then if there are remaining posts in the timeframe after the trend began (yes to stage 564) then stages 544 to 564 are repeated for the next post. Once all posts from the timeframe after the trend began have been processed (no to stage 564) then method 500 ends.

To further illustrate stages 540 to 566 to the reader, some numerical calculations are now presented. It should be evident that these values are just for the sake of providing numerical calculations and are not binding.

For example, assume that posts 202, 264, and 212 were posted after the trend began but within the time frame, with posts 202 and 264 posted 5 days after the trend began and post 212 was posted 15 days after the trend began. (It is assumed that post 268 was posted past the time frame).

In this example, user account 204 which owns post 202 has salesman role counter increased by the rank of post 202 (AR_{obj} with post age equaling 5). As assumed above post 202 is the focus of one interaction by user account 260 (rank of 5) in the timeframe with mₗᵢₙₖ of 2, out of a total of one link interaction performed by user account 260 on any posts. Further assume that 0.5 million of the 1 million views on post 202 occurred after the trend began but within the time frame (out of a total of 600 thousand views for all posts in the time frame) with m_{view} equaling 1. Further assume that five thousand of the ten thousand ratings on post 202 occurred after the trend began but within the time frame (out of a total of five thousand views on all posts in the time frame) with M_{rating} equaling 2 Using equation 1 the rank of post 202 is

$$( \frac{2 \times 1 \times 5}{1} + 1 \times ( \frac{1 \times 500 thousand}{600 thousand} + \frac{2 \times 5 thousand}{5 thousand} ) ) \cdot {e}^{- 0.01 \times 5} = 12.2$$

and therefore the salesman role counter for user account 204 is increased by 12.2. Further for simplicity's sake, instead of using the daily counts of views assume that the age of the views can be represented as 10 days after the trend began. The “attracts views” counter for user account 204 is therefore increased by the rank of post 202 with views age of 10. Using equation 1 the rank of post 202 with views age of 10 is

$$\frac{2 \times 1 \times 5}{1} + 1 \times ( \frac{1 \times 500 thousand}{600 thousand} + \frac{2 \times 5 thousand}{5 thousand} ) \cdot {e}^{- 0.1 \times 10} = 11.6 .$$

For simplicity's sake,

instead of using the daily counts of ratings assume that the age of the ratings can be represented as 12 days after the trend began. The “engaging” counter for user account 204 is therefore increased by the rank of post 202 with rating age of 12. Using equation 1 the rank of post 202 with ratings age of 12 is

$$\frac{2 \times 1 \times 5}{1} + 1 \times ( \frac{1 \times 500 thousand}{600 thousand} + \frac{2 \times 5 thousand}{5 thousand} ) \cdot {e}^{- 0.01 \times 10} = 11.4 .$$

In this example, user account 210 which owns post 212 has salesman role counter increased by the rank of post 212 (AR_{obj} with post age 15). It is assumed as above that the comment interaction occurred within the time frame by user account 250 (rank of 6) with m_{comment} of 3 out of a total of one comment by user account 250 on any posts. It is also assumed that 100,000 of the 500,000 views occurred in the time frame (out of a total of 600,000 views for all posts in the time frame) with m_{view} equaling 1. Using equation 1 the rank of post 212 is

$$\frac{3 \times 1 \times 6}{1} + 1 \times \frac{1 \times 100 thousand}{600 thousand} \cdot {e}^{- 0.01 \times 15} = 15.6 ,$$

and therefore the salesman counter is increased by 15.6. Again for simplicity's sake instead of using the daily counts of views assume that the age of the views can be represented as 20 days after the trend began. The attracts views counter for user account 210 is therefore increased by the rank of post 212 with views age of 20. Using equation 1 the rank of post 212 with views age of 20 is

$$\frac{3 \times 1 \times 6}{1} + 1 \times \frac{1 \times 100 thousand}{600 thousand} \cdot {e}^{- 0.01 \times 20} = 14.9 .$$

In this example, if it is instead assumed that post 212 was not in a subset of posts studied, for example because the subset only dealt with posts relating to “making history” then the salesman counter and attracts view counter for user account 210 are not increased.

In this example, user account 260 which owns post 264 does not have salesman role counter increased since the rank of post 264 is assumed to be zero. However user account 260 has a link to post 202. Therefore the salesman role counter for user account 260 is increased by the rank of post 202 with interaction age of 5 days. Using equation 1, the rank of post 202 with interaction day of 5 is 12.2 and therefore the salesman role counter for user account 260 is increased by 12.2.

In this example, if instead it is assumed that post 212 was not in a subset of posts studied, for example because the subset only dealt with posts relating to “making history” then post 202 would have all views in the relevant time frame and so the rank of post 202 (with age 5 for the post and for the link interaction to the post) would have been adjusted to 12.4. Therefore the salesman rank counters of the owner of the post (user account 204) and of the linker to the post (user account 260) would have been instead increased by 12.4. It is noted that the age of the interaction and the post may in some embodiments be different and therefore the salesman rank counters for the owner and linker would have been increased by different amounts in these embodiments. Similarly if instead it is assumed that post 212 was not in a subset of posts studied, then the “attracts views” counter for user account 204 would be adjusted to 11.8 and the engaging counter for user account 204 would be adjusted to 11.6.

In this example, assuming post 212 was among the posts studied then user account 250 has commenter role counter increased by the rank of post 212. Assume the comment was posted within the timeframe 2 days after post 212 was posted and therefore the age is 17 days. It is again assumed as above that the comment interaction was by user account 250 (rank of 6) with m_{comment} of 3 out of a total of one comment by user account 250 on any posts, and that assumed that 100,000 of the 500,000 views occurred in the time frame (out of a total of 600,000 views for all posts in the time frame) with m_{view} equaling 1. Using equation 1 the rank of post 212 is

$$\frac{3 \times 1 \times 6}{1} + 1 \times \frac{1 \times 100 thousand}{600 thousand} \cdot {e}^{- 0.01 \times 17} = 15.3 .$$

If post 212 was not among those studied then the commenter role counter of user account 250 is not increased.

In some embodiments, the role counters for user accounts definitely or with at least a predetermined probability of corresponding to the same profile can be combined through a function. For example, in one of these embodiments counter values for the same role from each user account corresponding to the same profile can be added together.

In various embodiments, none, any, or all of the following may be applied to user accounts and/or profiles whose roles have been noted: filtering, selecting, and/or sorting.

With regard to filtering, depending on the embodiment a request from consumer 190 may relate to a subset of posts which fulfill certain criteria or to all posts. If for a subset of posts, then depending on the embodiment the role analysis may proceed in any of the following ways. In some cases, only the subset of posts and interactions thereof may be analyzed to evaluate the role(s) of various user accounts for example using method 500. Alternatively, all posts and interactions thereof can be analyzed to evaluate the role(s) of various user accounts for example using method 500 and then the results of the evaluations can be filtered based on the request. Alternatively, only a subset of posts and interactions thereof may be analyzed to evaluate the role(s) of various user accounts for example using method 500 and then the results may be further filtered. For example the filter may retain only user accounts which own a minimum number of posts within the subset and/or user accounts which interacted a minimum number of times with posts in the subset.

In some embodiments, user accounts or profiles can be selected based on whether or not one or more roles were played and/or the extent of the role(s). For example, only user accounts/profiles which played a salesman role may be selected and/or that the hundred user accounts/profiles with the highest salesman role value may be selected. As another example, user accounts/profiles which played both contributor and salesman roles and/or whose contributor and salesman role values are both among the top hundred may be selected. Alternatively or additionally, user accounts or profiles can be sorted based on the magnitude of one or more role measurements. For example, the extent of the role played by a user account/profile may in some cases be used to determine the order of display, with user accounts/profiles who played one or more roles to a higher extent outputted in a more prominent position than user accounts/profiles who played those role(s) to a lower extent. Continuing with the example, in some cases if the consumer request was for the hundred user accounts/profiles with the highest salesman role value, the user account/profile out of the hundred with the highest value may be outputted in a more prominent position than the user/account profile out of the hundred with the lowest value. In embodiments with selection and/or sorting, the noted roles may serve as a primary selection and/or sorting factor, a secondary selection and/or sorting factor, or an even less important selection/sorting factor.

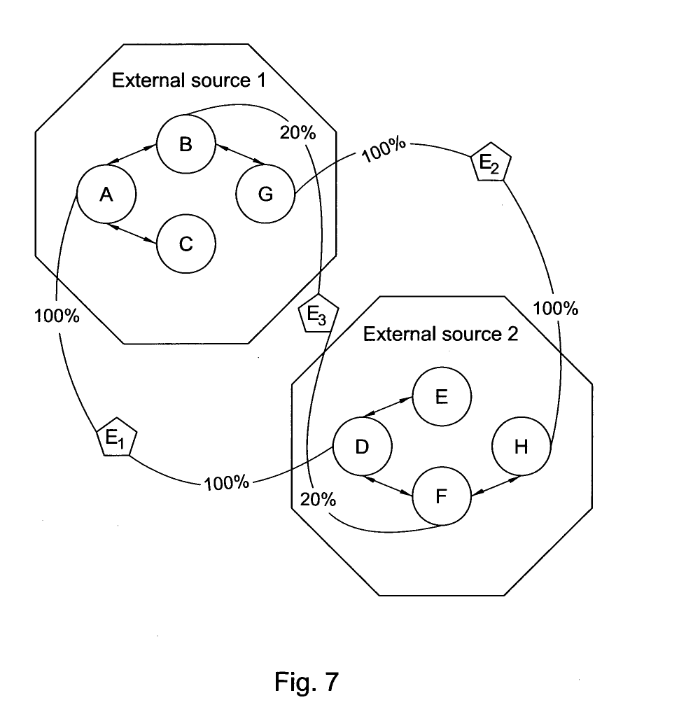

As mentioned above, more than one user account may correspond to the same profile. However in some cases it is challenging to determine whether or not user accounts correspond to the same profile. FIG. 7 is an example of a social graph according to some embodiments of the invention. FIG. 7 will be used to illustrate various aspects of the present invention. It is noted that a social graph is presented here as a visual tool to aid in the understanding of the reader, but that system 110 does not necessarily construct nor store such a graph. It is also noted that the number of user accounts and profiles included in the social graph of FIG. 7 are not many so as to not confuse the reader.

For simplicity's sake it is assumed that the social graph in FIG. 7 shows connections representing relationships between two user accounts which were explicitly defined by one or both user account (e.g. friends, following you, family connections, work relations, etc). The edges connecting user accounts may be one direction edges or two direction edges depending on the relationship. FIG. 7 also shows weighted edges between user accounts and profiles. The weights represent the probability level that the user account and profile correspond (AKA the certainty level about the authenticity of the connection). It will now be explained how correspondence is established.

In some embodiments, it is initially assumed that user accounts do not correspond with one another. Data is analyzed relating to two online user accounts. The probability that two online user accounts both correspond to a common profile is increased as more data points to the user accounts corresponding to a common profile. If the probability that two online user accounts both correspond to a common profile is above a predetermined threshold, it is concluded that the two online user accounts correspond to a common profile. Depending on the embodiment, the profile for corresponding user accounts may or may not be provided to consumers 190. For example, in some cases only profiles which were authenticated (and are therefore definite, 100% probability) are provided whereas other profiles are not provided.

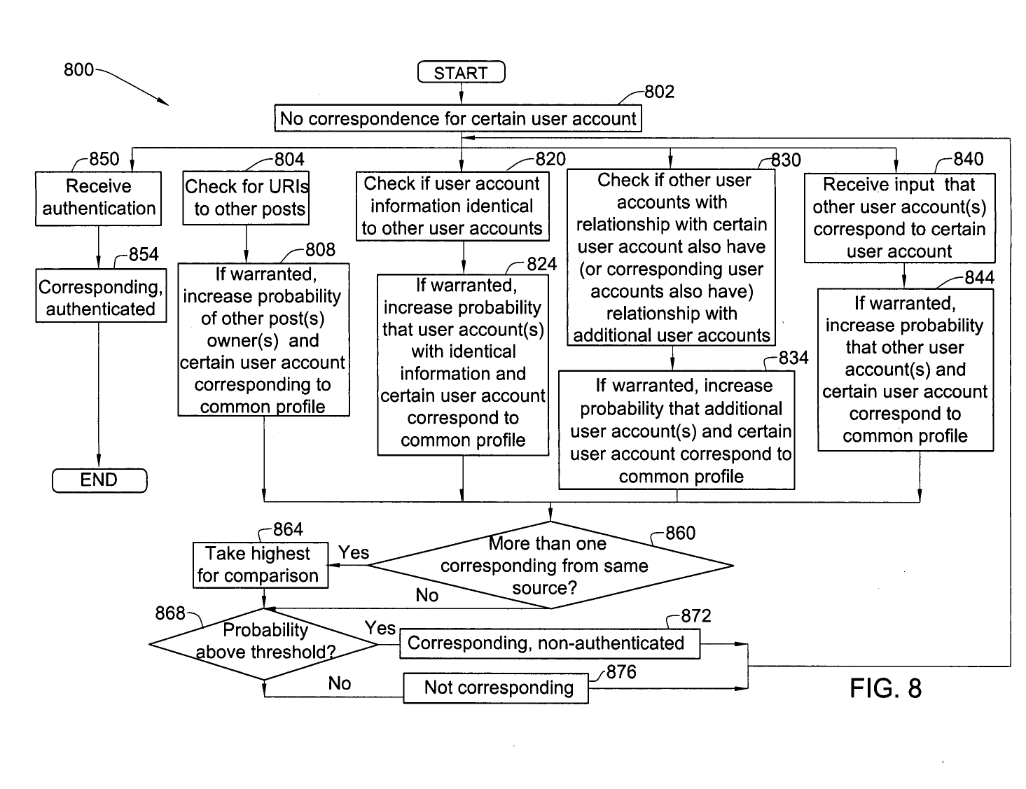

One example of a method of identifying corresponding user accounts is described with reference to FIG. 8. This example is provided to aid in the understanding of the reader and should not be construed as restricting the invention.

FIG. 8 illustrates a flowchart of a method 800 for identifying corresponding user accounts, according to some embodiments of invention. In some cases, method 800 may include fewer, more and/or different stages than illustrated in FIG. 8, the stages may be executed in a different order than shown in FIG. 8, stages that are illustrated as being executed in parallel may be executed sequentially, and/or stages that are illustrated as being executed sequentially may be executed in parallel.

In the illustrated embodiments, in stage 802 it is initially assumed that there is zero probability that a certain user account corresponds to any other user account.

In the illustrated embodiments in stages 804 to 854, system 110, for example comparer 320, analyzes data relating to the certain user account. If warranted based on the analysis, then system 110, for example counter 302, increases the probability that a certain user account corresponds to other user account(s). The analyzed data may have been collected by crawlers 115 and/or input by consumers 190. The data may be analyzed using one or more techniques, and if a plurality of techniques are used then the different techniques may be applied sequentially and/or in parallel. In some embodiments, there may be a point when based on the analysis it is warranted that the probability of the certain user account corresponding to any other user account first increases above zero, or some other floor. In some of these embodiments, at this point there may be an automatic creation by system 110, for example by profile processor 375, of a profile corresponding to the user accounts and/or assignment of a probability to the edge connecting each corresponding user account to the profile.

In the illustrated embodiments, for example, in stage 804, posts owned by the certain user account may be checked for uniform resource identifiers “URI”s to other posts. In some embodiments, the checking may be for URI's whose relationship attribute is defined as “me”, for example in an hypertext markup language “HTML” microformat such as XHTML friends network “XFN”. In some embodiments, third party tools 182 such as social graph services (e.g. Google Social Graph API) facilitate the performance of stage 804.

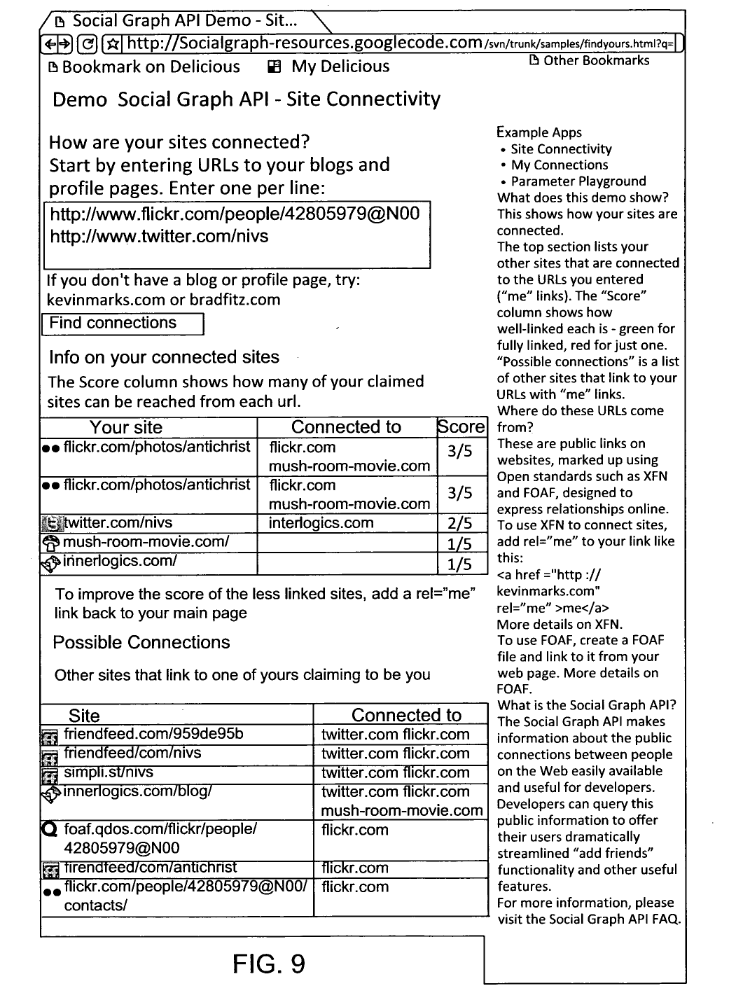

FIG. 9 shows an example according to some embodiments of a page in Google Social Graph API, showing other possible user accounts belonging to a profile “Niv Singer” with known user account Flickr and Twitter accounts. In some cases, the other possible user accounts found by Google social graph API is stored and the potential owner (in this case Niv Singer) is given a choice to either confirm that the found user accounts belong to him or not.

In the illustrated embodiments in stage 808, if warranted, the probability is increased that the user account which owns the post (whose URI was in a post belonging to the certain user account) and the certain user account correspond to the same profile. The decision of when raising the probability is or is not warranted and the decision by how much to raise the probability if warranted may vary depending on the embodiment. In one example, the probability is increased for each link with “me” relationship attribute between posts belonging to two user accounts, with the maximum possible increase due to links capped at 20%.

In the illustrated embodiments, another example of analysis is illustrated by stages 820 and 824. In stage 820 it is determined if information associated with the certain user account is identical to information associated with one or more other user accounts. For instance, there may be one or more email addresses or email hashes (where the email hashes may be provided for example by applying the SHA1 mathematical functional to a ‘mailto:’ identifier (URI) for an Internet mailbox) associated with a certain user account. Other user accounts may be checked for one or more identical email address/hashes. In stage 824, if warranted the probability is increased that the certain user account and the other user account with identical information correspond to the same profile. The decision of when raising the probability is or is not warranted and the decision by how much to raise the probability if warranted may vary depending on the embodiment. In one example the decision on whether or not to increase the probability and by how much depends on the quantity and/or quality of identical information, where the maximum possible increase due to identical information is capped at 30%. Continuing with the example, in one embodiment identical age may not affect the probability, but identical email address may cause an increase in probability.

In the illustrated embodiments, another example of analysis is illustrated by stages 830 and 834, termed mutual connections. In stage 830 it is checked if any other user account that has a relationship with a certain user account also has a relationship with an additional user account. Similarly it may be checked if a user account corresponding to the other user account has a relationship with an additional user account. In stage 834, if warranted the probability is increased that the certain user account and the additional user account with mutual connections correspond to the same profile. The decision of when raising the probability is or is not warranted and the decision by how much to raise the probability if warranted may vary depending on the embodiment. In one example, the probability is increased for each mutual connection, with the amount of increase depending on the quality of the relationship and the level of certainty that the connection is mutual, with the maximum possible increase in probability due to mutual connections capped at 20%.

In the example illustrated in FIG. 7, user accounts A and D correspond (100% probability due to authentication) to profile E₁. Similarly, H and G correspond (100% probability due to authentication) to profile E₂. Since A and G are both connected to B and also D and H are both connected to F, the probability of B and F both corresponding to profile E₃ is increased. In this example, because of the 100% probability that A and D correspond and H and G correspond, the probability that B and F correspond is increased by a relatively high 20%. It is assumed in the example shown that the initial probability was zero and therefore the total probability of B and F corresponding is 20%. In some embodiments, E₃ may be a new profile automatically created based on this scenario. If one or more of the levels of probability that A and D correspond and H and G correspond was lower (i.e. less certainty of a mutual connection), then in some cases of this example the increase in probability may have been less than 20%.

In the illustrated embodiments, another example of analysis is illustrated in stages 840 and 844, termed crowd sourcing. In stage 840 it is checked if input was received from a consumer 190 (who is not the owner of the certain account) recording that another account corresponds to the certain account. In some cases, only input from a consumer 190 which is a member of system 110 is allowed in stage 840. In stage 844, if warranted, the probability is increased that the certain user account and the recorded other account correspond to the same profile. For example, system 110 may allow consumers 190 (or only certain consumers 190) to group corresponding user accounts (e.g. their contacts). Depending on the embodiment of this example, the grouping may be kept private (visible only to the consumer 190 which provided the grouping or to select consumers 190), or may be public. In some embodiments, consumers 190 (or only certain consumers) may also be able to ungroup and/or report invalid groupings. In some embodiments, consumers 190 (or only certain consumers 190) may be able to rate the trust level of other consumers 190 in terms of whether or not groupings provided by the other consumers are trustworthy. The decision of when raising the probability is or is not warranted and the decision by how much to raise the probability if warranted may vary depending on the embodiment. In one example, the decision and/or amount may be based on the rating of the consumer(s) which provided the grouping and/or based on the number of consumers which provided the same grouping, with the maximum possible increase in probability due to crowd sourcing capped at 20%.

It is noted that the maximum possible probability of correspondence from stages 804 to 844 is less than 100%, for example 90%.

In the illustrated embodiments 100% certainty of correspondence is achieved through the analysis illustrated in stages 850 and 854. In stage 850, it is determined if authentication has been received for the certain account, authenticating the certain account as corresponding to at least one other account. In stage 854, if authentication is received then the probability is increased to 100% that the certain user account and the other user account correspond to the same profile. In some embodiments, authentication is allowed only by the possessor of the user account. In some of these embodiments, authentication is allowed only by the possessor of the user account who is a member of system 110. For example, in some of these embodiments, a consumer 190 may be allowed to log in to system 110 and prove user account possession by validating credentials (e.g. username/password) and/or by using password less authentication schemes (such as OAuth, OpenID, AuthSub, etc). The credentials or authentication tokens may be stored by system 110 in order to query information regarding user accounts and/or to perform actions on behalf of members. Depending on the embodiment, a consumer 190 may or may not be able to authenticate more than one account per external source.

It should be evident that the invention is not restricted to the maximum percentages assigned to the various examples of analysis described above. It should also be evident that in some embodiments, additional, less, and/or different analysis than the examples described above may be executed in order to attempt to raise the probability of correspondence.

Assuming authentication has not occurred, then in the illustrated embodiments method 800 continues with stage 860 to 868 performed by worker 120, for example comparer 320. In stage 860 it is determined if there is more than one user account in any particular external source which has a probability above zero of corresponding to the certain user account. If yes, then in stage 864 the user account in the particular external source with the highest probability is designated to be considered in stage 868 for possible correspondence with the certain user account and the other user accounts are designated as eliminated from consideration (i.e. it is concluded that the other user accounts do not correspond). If for all external sources not more than one user account has a probability above zero then stage 864 is omitted. In stage 868, for each user account with non-zero probability of corresponding to a common profile as the certain user account (and which was not eliminated from consideration in stage 864), it is determined if the probability is above a predetermined threshold. If yes, then in stage 872 the accounts are considered to correspond to a common profile with sufficient probability, although not authenticated. If no, then in stage 876 the accounts are considered to not correspond. In some embodiments, stage 860 to 864 are omitted and in stage 868 for each user account with a non-zero probability (even if more than one user account from an external source qualifies) it is determined if the probability is above a predetermined threshold. The invention does not restrict the value of the predetermined threshold.

In some embodiments, only user accounts which were authenticated as corresponding to a common profile are indicated to consumers as corresponding. In some embodiments, additionally or alternatively, user accounts which are considered to correspond to a common profile because the probability is above a predetermined threshold may be indicated to consumers as corresponding, optionally with the level of probability also indicated. In some embodiments, additionally or alternatively, user accounts which are considered unlikely to correspond to a common profile because the probability is below a predetermined threshold may be indicated to consumers as potentially corresponding, optionally with the level of probability also indicated.

In some embodiments, worker 120 additionally or alternatively processes the collected data in order to identify a vogue. For example, while collecting data the number of interactions and other information (such as Tag use) per post is counted. The delta value between the new value and the previous value is stored as well. Tag counts and delta values are aggregated and stored per Tag and per Tag/Interaction Type pair (e.g. number of comments for posts containing a specific Tag). In this example, by looking at posts or Tags with high delta values (negative and positive), in vogue topics (e.g. most commented Tags in the past week) may be identified. Posts with high, positive delta values are marked as popular or upcoming (becoming interesting). In some cases of this example, data from external sources (e.g. Flickr® interestingness, YouTube most popular, Twitter™ Search, etc) is additionally or alternatively taken into account. For instance, the following formula calculates the “interestingness” rank of a YouTube video, by calculating the ratio of passive viewers vs. interacting viewers:

$${obj}_{interestingness} = \frac{( {n}_{raters} \cdot {avg}_{rate} ) + {pn}_{comments} + {qn}_{favorites} + {n}_{views}}{{n}_{views}} \qquad ( equation 4 )$$

(p and q are constants used to adjust the ratio between a predetermined maximum rate, a comment and a favorite. For example in some cases p, q equal 5).

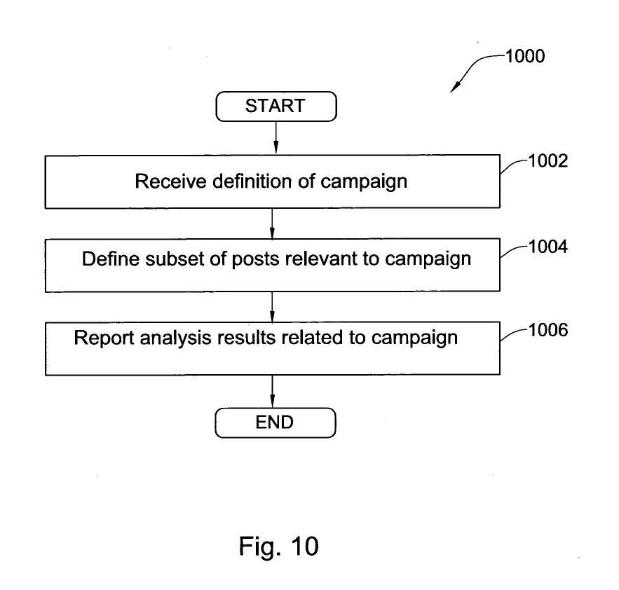

An example of application 145 will now be described. In this example, described with reference to FIG. 10, the application allows end to end campaign management. This example is provided to aid in the understanding of the reader and should not be construed as restricting the invention.

Refer to FIG. 10 which shows a flowchart of a method 1000 of campaign management, according to some embodiments of the invention. Some of the stages are illustrated by screenshots, provided to aid in reader understanding. The format and content of the screenshots should not be construed as limiting the invention. In some cases, method 1000 may include fewer, more and/or different stages than illustrated in FIG. 10, the stages may be executed in a different order than shown in FIG. 10, and/or stages that are illustrated as being executed sequentially may be executed in parallel.

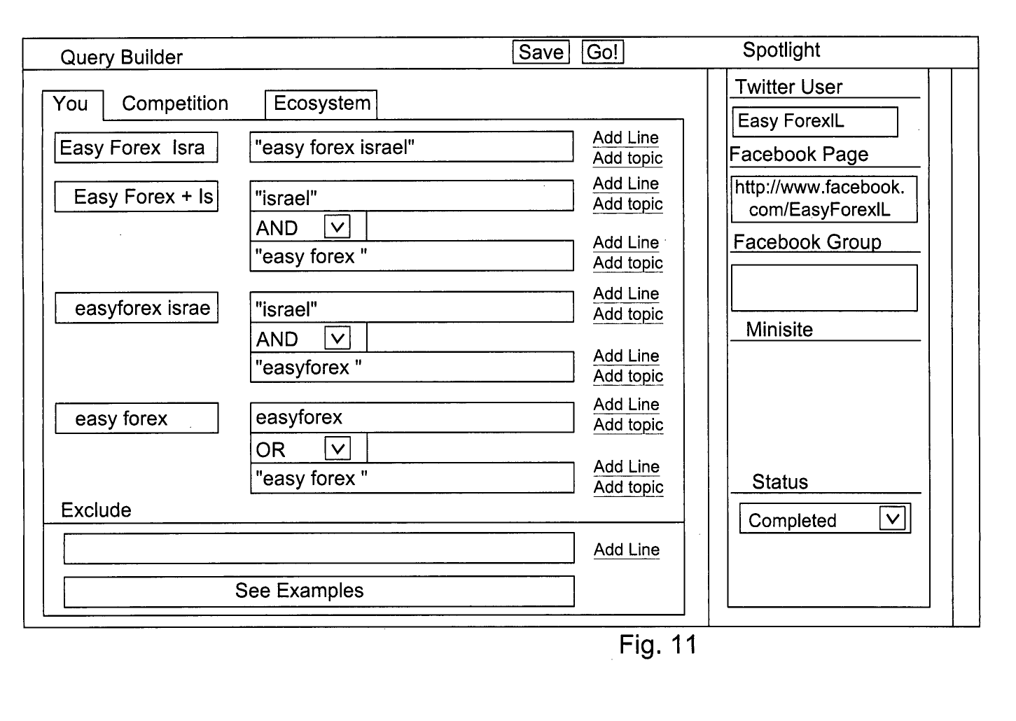

In the illustrated embodiments in stage 1002, application 145 receives a definition of a campaign from consumer 190. In some embodiments, each campaign is divided into scopes, each scope is optionally divided into topics, and each topic is defined by one or more queries of keywords separated by Boolean operators. For example, in some of these embodiments, there are four scopes, the first being brand content, the second being competition, the third being ecosystem and the fourth being campaign specific content. Continuing with the example, in some cases posts related to each scope and/or each topic comprise a separate group. Assume that the campaign is an advertisement campaign for a shoe chain named “gowear”, which competes with other shoe chains such as “slick”, and “footsies”, and that the current campaign slogan is “feel the walk”. Under these assumptions, the first scope on brand content may include inter-alia the keyword “gowear”, the second scope on competition may include inter-alia the keywords “slick” and “footsies” (with each one possibly a separate topic) the third scope may include inter-alia the keyword “shoe”, and the fourth scope may include inter-alia the keyword “feel the walk”. In some cases the first and fourth scope may also include spotlight definitions which are either URI's or user accounts of interest to the campaign. For example, if on a social network there is a page for the brand and certain user accounts communicated with the page, these user accounts may be of interest to the campaign even if owned posts of these user accounts are not captured by the keywords. FIG. 11 is a screenshot illustrating some aspects of stage 1002 campaign definition, according to some embodiments of the invention.

Alternatively or additionally, in some embodiments the definition of a campaign from consumer 190 may include choosing of one or more categories (for example used in clustering posts) and/or choosing of one or more market verticals (for example used in clustering posts).

In stage 1004, a subset of posts relevant to the campaign is selected, based on the definition from stage 1002. For example worker 120, for instance index searcher 340, may search index 135 for posts which contain keyword(s) entered in stage 1002 for any of the scopes/topics or for one or more particular scope/topic. As another example, additionally or alternatively worker 120, for instance index searcher 340, may search index 135 for posts belonging to one or more categories and/or market verticals chosen in stage 1002. As another example, index searcher 340 may search index 135 for posts which contain keyword(s) entered in stage 1002 and belong to one or more chosen categories and/or market verticals. The selected posts are then associated with the campaign and/or specific scope/topic of the campaign.

In stage 1006, analysis results relevant to the defined campaign are reported to consumer 190. Depending on the embodiment, the analysis may be performed on the subset of posts, the analysis may be performed on all posts but then filtered for only the subset of posts, the analysis may be performed for only the subset of posts but then further filtered, or any combination of the above. The analysis may be performed at any time prior to the reporting. The analysis may be performed for example by worker 120 with the reporting for example prepared by reporting module 145.

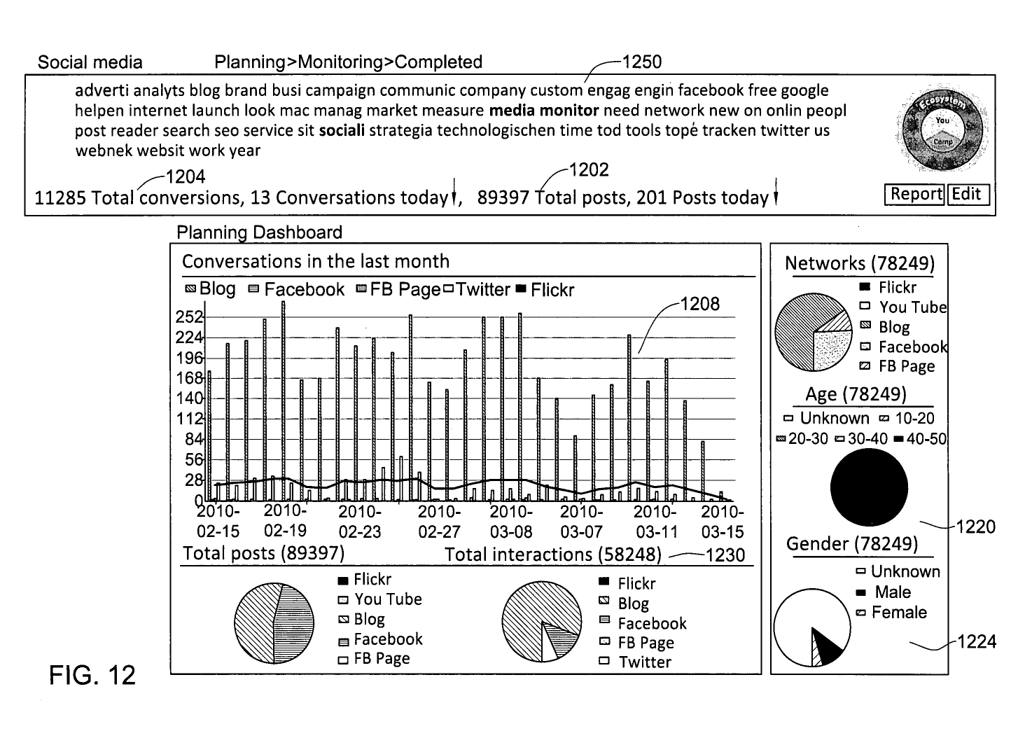

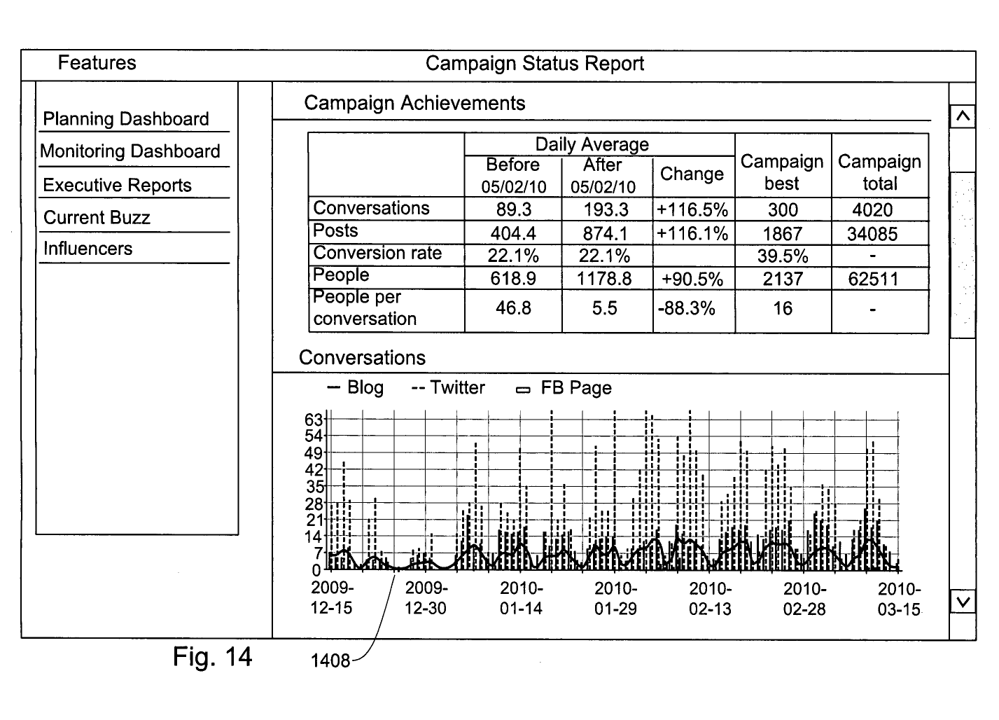

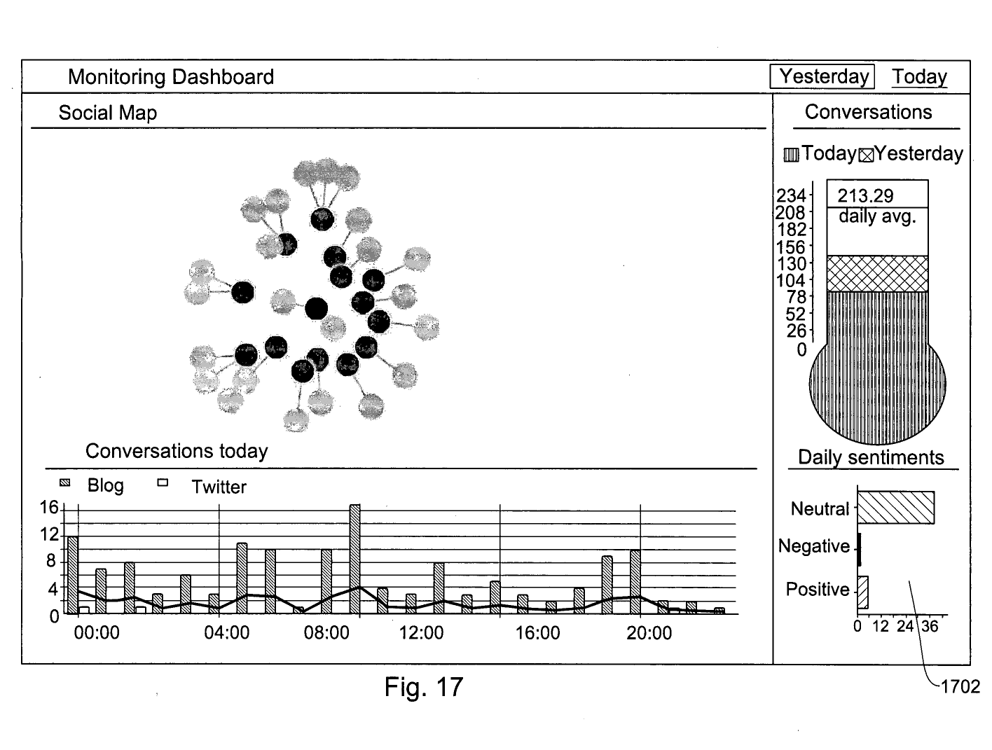

In some embodiments, any of the following analysis results, inter-alia, may be reported to consumer 190: (Refer to FIGS. 12 through 17 which illustrate some of the various aspects of campaign reporting, according to various embodiments of the present invention).

Total posts count—For example section 1202 in FIG. 12 shows the total number of posts relevant to the defined campaign.

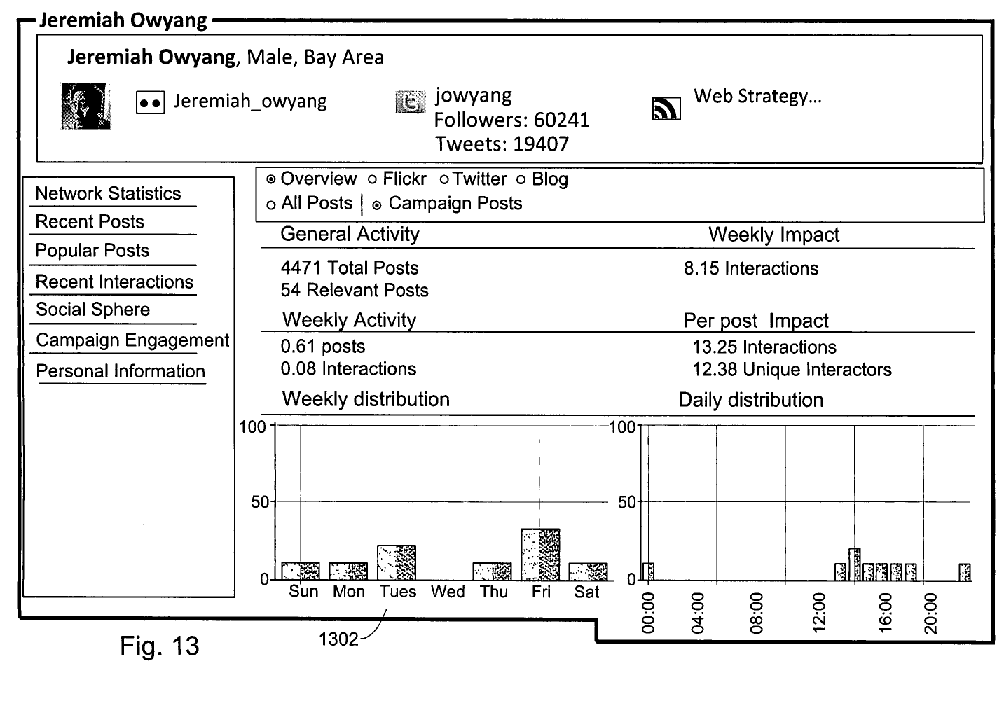

Posts count over time—For example graph 1302 in FIG. 13 shows the number of posts over time for a particular profile relevant to the defined campaign.

Total conversation count (where conversation count equals the number of posts with at least one interaction). For example section 1204 in FIG. 12 shows the total number of conversations relevant to the defined campaign.

Conversations count over time—For example graph 1208 shows conversation count relevant to the defined campaign over the past month in various external sources. For example graph 1408 shows conversation count relevant to the defined campaign over a longer period of time (including both before the campaign began and after the campaign began) in various external sources.

Campaign engagement. The number of conversations on campaign generated content (e.g. content created by consumer 190 as campaign manager or in response to specific campaign keywords) can in some cases provide a measurement of campaign engagement.

Interactions count—Total and/or over time. For example section 1230 in FIG. 12 shows the total interactions and the distribution by external source.

Number of participating user accounts, for example owners of posts and/or interacting owners. In some embodiments the user accounts may be grouped by demographics such as age, location, gender. For example, section 1220 in FIG. 12 shows the distribution of user accounts by age and section 1224 in FIG. 12 shows the distribution of user accounts by gender. The total number of participating owners and/or the number of participating owners over time may be provided.

A list of one or more ranked user accounts or profiles. For instance the rank may be determined as described above inter-alia with reference to FIG. 4. Depending on the embodiment, the rank may be reported to the consumer and/or used internally by system 110, for example for optional selection and/or optional sorting. In some embodiments with selection, rank may be the only selection factor or one of the selection factors for determining which user accounts and/or profiles are provided. For example, in one embodiment only user accounts and/or profiles with rank above a predetermined threshold, and/or the in the top predefined percentile of ranks are reported to consumer 190. Depending on the embodiment with sorting, the list of user accounts and/or profiles may be sorted primarily by rank or secondarily or even less importantly by rank. For example, in some cases the primary sort of profiles or user accounts may be based on activity (number of owned posts) or impact (number of conversations started by owned posts). In these cases the sort by activity would render the “most active” profiles or user accounts whereas the sort by impact would render the “most influential” profiles or user accounts. In this example, the secondary sort would be based on the rank. However in another example, in some cases, the primary sort is by rank. As mentioned above, ranking may have been performed using only a subset of posts relevant to the defined campaign, ranking may have been performed using all posts and then filtering based on the defined campaign, or ranking may have been performed on a subset of posts with further filtering then performed. Therefore, in various embodiments, none, any, or all of the following may be applied to user accounts and/or profiles after ranking: filtering, selecting, and/or sorting. In some embodiments, the presentation of the user accounts and/or profiles to the consumer reflects the rank in any one of various ways including inter-alia: explicit presentation of the rank, selection of user accounts/profiles to be presented based on rank, and/or sorting the user accounts/profiles to be presented based on the rank. Refer to FIG. 15 which shows a list of user accounts/profiles primarily sorted by impact with a secondary sort by rank.

Profile-user account correspondence, for example as described above inter-alia with reference to FIG. 8. It is noted that FIG. 15 shows user accounts unified to a profile, for example Jeremy Owyang's profile in section 1502 includes three user accounts. As described above, authenticated correspondence, non-authenticated correspondence but with a probability above a predetermined threshold, and/or correspondence below a predetermined threshold may be outputted to the consumer depending on the embodiment.

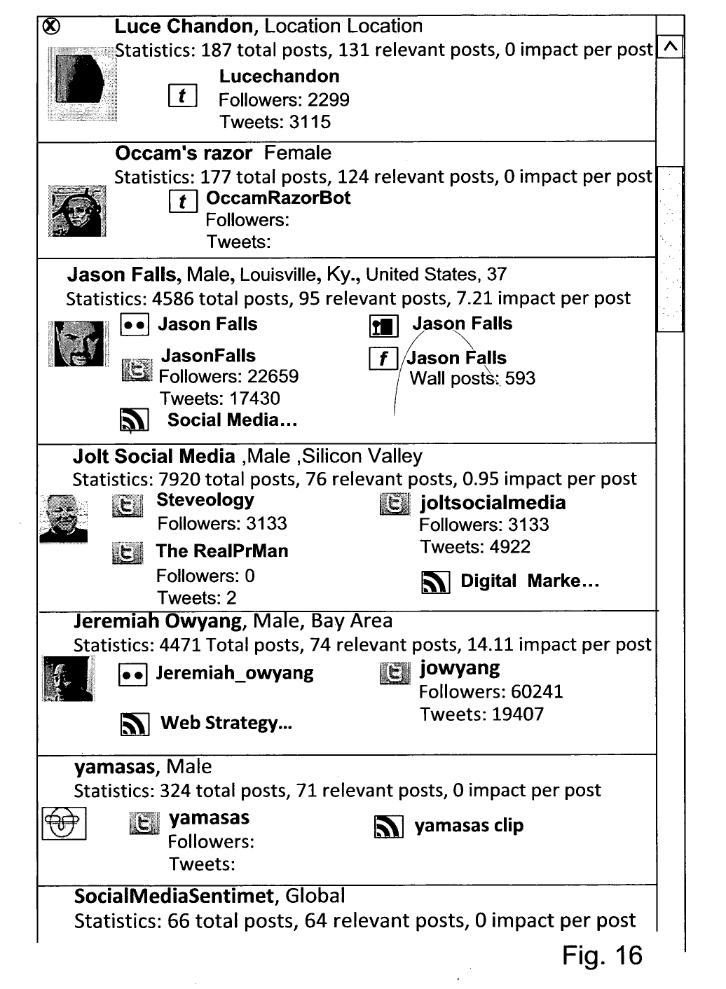

A list of one or more user accounts/profiles selected and/or sorted based on whether or not the user account/profile played one or more roles and/or based on the extent of the role(s) played as described above inter-alia with reference to FIG. 5. For example, FIG. 16 shows a list of “contributors” relevant to the campaign sorted by the extent of the contributor role.

Related Tags—In some embodiments, a list of words and phrases is automatically built such that each word or phrase has a high-frequency in posts/interactions in a specific Scope/Topic, but low-frequency in the entire corpus (containing all collected posts). This measurement is known as frequency—inverse document frequency TF-IDF. For example section 1250 in FIG. 12 shows a list of related tags.

Sentiment Analysis—In some embodiments, sentiment analysis is performed on associated posts and interactions and the number of neutral/positive/negative posts is counted in total and over time. For example graph 1702 in FIG. 1702 shows the daily sentiments. In some embodiments, the “bag of words” model of natural language understanding is used for sentiment analysis.

Current buzz—In some embodiments, recent posts and interactions relevant to the campaign are shown in real time as the posts and interactions occur.

Unification of distributed interactions regarding post, user account, and or profile from a plurality of external sources. In some embodiments, all interactions relevant to the campaign are shown even those relating to a plurality of external sources (e.g. a Twitter™ tweet concerning a YouTube video). In some of these embodiments, metrics are displayed with regard to a post, user account, and/or profile regardless of the originating external source (e.g. the number of times the post was shared in a plurality of external sources, the number of followers for a specific user account in a plurality of external sources).

Campaign alternative cost calculation. The cost is estimated of funding in a traditional online campaign (e.g. which displays online advertisements, public notices, announcements, etc) equivalent exposure in the external sources that contains the posts. For example, the estimate may in some cases use 3^{rd} party tools 182 such as comScore, Compete, Google AdSense API for web sites, published advertising cost for specific demographics in Facebook, number and type of followers in Twitter. The estimated cost for each post of funding equivalent online exposure in the external source, multiplied by the partiality of the post to the defined campaign is summed to calculate how much it would have cost to fund a traditional online campaign that would lead to equivalent exposure with equivalent partiality.

It should be evident that the reported analysis results listed above are not binding on the invention. In some embodiments less, more and/or different factors may be analyzed and/or reported than those shown above.

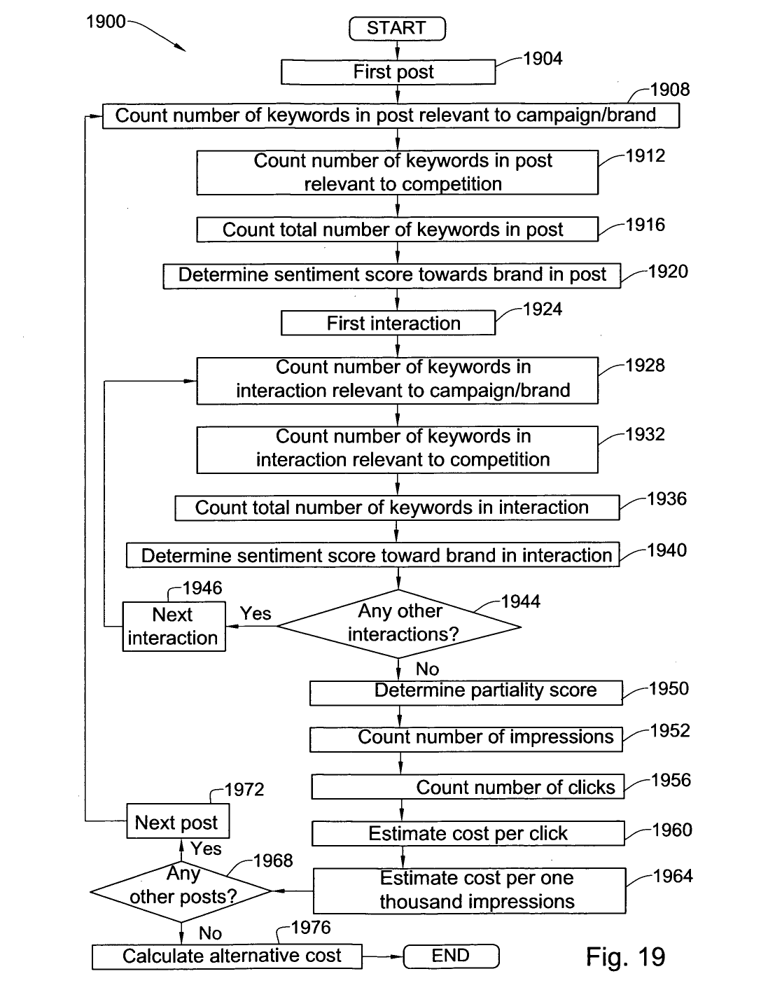

One example of a method of calculating the alternative cost will now be described with reference to FIG. 19. This example is provided to aid in the understanding of the reader and should not be construed as restricting the invention.

FIG. 19 is a flowchart of a method 1900 of calculating an alternative campaign cost, according to some embodiments of the invention. In some embodiments, method 1900 is performed by worker 120. In some cases, method 1900 may include fewer, more and/or different stages than illustrated in FIG. 19, the stages may be executed in a different order than shown in FIG. 19, and/or stages that are illustrated as being executed sequentially may be executed in parallel.

It is assumed that stage 1004 has already been performed and therefore a subset of posts relevant to the campaign has been selected. In some embodiments, the subset of posts are from a time period defined by consumer 190 and/or by system 110, for example from a time period beginning with the definition of the campaign and ending with the current date that method 1900 is executed. In other embodiments, the subset of posts may be from any time collected by system 110.

It is also assumed that keywords were entered in stage 1002 at least relating to the brand and/or campaign, and to the competition.

In the illustrated embodiments, beginning in stage 1904 with the first post in the subset, in stage 1908 the number of keywords in the post relating to the brand and/or campaign (e.g. included in the first and/or fourth scopes) is counted, nᵣₖ_{ₚ}, for example by counter 302.

In the illustrated embodiments, in stage 1912 the number of keywords in the post relating to the competition (e.g. included in the second scope) is counted, n_{ck}_{ₚ}, for example by counter 302.

In the illustrated embodiments, in stage 1916 the number of keywords in the post relating to any of the scopes (or alternatively relating to brand and/or campaign or relating to competition) is counted, nₖ_{ₚ}, for example by counter 302.

In the illustrated embodiments, in stage 1920, the sentiment score in the post towards the brand and/or campaign is determined, Sₚ, for example by sentiment analyzer 330. In some embodiments, the sentiment analysis includes the “bag of words” model of natural language understanding. In some embodiments Sₚ is a number between 0 and 1.

In the illustrated embodiments, beginning in stage 1924 with the first interaction with the post, in stage 1928 the number of keywords in the interaction relating to the brand and/or campaign (e.g. included in the first and/or fourth scopes) is counted, nᵣₖ_{ᵢ}, for example by counter 302.

In the illustrated embodiments in stage 1932 the number of keywords in the interaction relating to the competitions (e.g. included in the second scope) is counted, n_{ck}_{ᵢ}, for example by counter 302.

In the illustrated embodiments in stage 1936 the number of keywords in the interaction relating to any of the scopes (or alternatively relating to brand and/or campaign or relating to competition) is counted, nₖ_{ᵢ}, for example by counter 302.

In stage 1940, the sentiment score in the interaction towards the brand and/or campaign is determined, Sᵢ, for example by sentiment analyzer 330. In some embodiments, the sentiment analysis includes the “bag of words” model of natural language understanding. In some embodiments Sᵢ is a number between 0 and 1.

In 1944, it is determined if there are any more interactions for the post. If yes (yes to stage 1944), then for the next interaction (stage 1948), method 1900 iterates to stage 1928.

If there are no more interactions (no to stage 1944), then in stage 1950 a partiality score is determined, for example by partiality scorer 350. In some cases, the partiality score will be higher for posts/interactions whose content is more about the brand/campaign than about the competition and whose sentiment score reflects a positive sentiment toward the brand/campaign. For example, in some embodiments, the partiality score is defined by the following equation

$${R}_{p} = \frac{{n}_{{rk}_{p}} - α {n}_{{ck}_{p}}}{{n}_{{k}_{p}}} \cdot {S}_{p} + {\sum }_{i ∈ interactions} \frac{{n}_{{rk}_{i}} - α {n}_{{ck}_{i}}}{{n}_{{k}_{i}}} \cdot {S}_{i} \qquad ( equation 5 )$$

where α is a configurable weight on the competition.

In some embodiments if the partiality score calculated in equation 5 is negative (for example due to more weighted keywords related to competitor than keywords related to campaign/brand) then the post is discarded as being irrelevant to the campaign. In other embodiments, the post is retained regardless of whether the partiality score calculated in equation 5 is positive or negative. In these embodiments if the partiality score of a post is negative, then the contribution of the post reduces the alternative cost (see equation 6 below) rather than increases the alternative cost.

It should be evident that equation 5 is just one example of an equation for determining a partiality score and that other equations for determining partiality scores may be used instead in some embodiments.

It is assumed that in the field of a traditional online campaign, compensation is based on the number of clicks on an advertisement, announcement, public notice, etc. and/or based on the number of thousand impressions. Therefore substitute parameters for number of thousand impressions and/or clicks are determined for the post.

In the illustrated embodiments, in stage 1952 the number of impressions [nᵢ_{ₚ}] of the post are counted, for example by traditional campaign cost estimator 390 counting a substitute parameter. Examples of substitute parameters include inter-alia any one of the following:
number of views, for example available on some blogs, Youtube, Flickr®, etc
number of followers friends multiplied by a constant (e.g. 1), for example available on Twitter™, Facebook, etc
number of monthly unique visitors to the external source website, for example using third party tools 182 such as compete.com or comScore.com. In some cases, the number of monthly unique visitors may be adjusted by the number of days the post was visible on the website.

In some embodiments, the number of views is the preferred substitute parameter for the number of impressions, and if the number of views is not available then the number of friends/followers multiplied by a constant is the next preferred substitute parameter. If neither of these parameters is available then the number of monthly unique visitors possibly adjusted for number of days the post was visible, is used.

In the illustrated embodiments, in stage 1956, the number of clicks [n_{c}_{ₚ}] for the post is counted, for example by traditional campaign cost estimator 390 counting a substitute parameter. An example of a substitute parameter includes inter-alia the number of interactions per post by unique interacting user accounts. The number of interactions in some cases may be a worthy substitute for clicks since both show engagement with the post content.

In the illustrated embodiments in stage 1960, the cost per click CPCₚ is estimated, for example by traditional campaign cost estimator 390, for the external source website containing the post. In some embodiments, the cost per click can be determined for any website which displays advertisements, announcements, public notices, etc. (such as blogs, Youtube, Facebook, etc) using third party tools 182 such as Google Adwords API, Google Adwords Keyword tool, Facebook Ad manager, etc. The cost per click is what a payer would pay per click on the advertisement, announcement, public, notice, etc in a traditional online campaign.

In the illustrated embodiments in stage 1964, the cost per one thousand impressions CPMₚ is estimated, for example by traditional campaign cost estimator 390, for the external source website containing the post. In some embodiments, the cost per click can be determined for any website which displays advertisements, announcements, public notices, etc (such as blogs, Youtube, Facebook, etc) using third party tools 182 such as Google Adwords API, Google Adwords Keyword tool, Facebook Ad manager, etc. The cost per one thousand impressions is what a payer would pay per one thousand impressions of the advertisement, announcement, public, notice, etc in a traditional online campaign.

In the illustrated embodiments in stage 1968, it is determined if there are any more remaining posts in the subset. If yes (yes to stage 1968), then method 1900 iterates for the next post (stage 1972) beginning with stage 1908. If there are no more posts (no to stage 1968), then method 1900 continues with stage 1972.

In the illustrated embodiments in stage 1976, the alternative cost of the subset of posts is calculated, for example by alternative cost calculator 355. In some embodiments the alternative cost for each post depends on the partiality score determined above, the cost for all the impression(s), and the cost for all the click(s). Therefore in these embodiments the alternative cost for a post is higher for higher partiality, for higher number of clicks and/or impressions and/or for higher cost per click and/or per impression. In some embodiments the alternative cost for the subset of posts represents the cost of funding a traditional online campaign that would lead to equivalent exposure with equivalent partiality as the subset of posts. For example, an equation for determining alternative cost of all the posts in the subset is provided by equation 6:

$$A C = {\sum }_{p ∈ posts} {R}_{p} \cdot ( {n}_{{c}_{p}} \cdot C P {C}_{p} + \frac{{n}_{{i}_{p}} \cdot C P {M}_{p}}{1000} ) \qquad ( equation 6 )$$

It should be evident that equation 6 is just one example of an equation for determining the alternative cost and that other equations for determining alternative costs may be used instead in some embodiments.

Method 1900 then ends.

It will also be understood that in some embodiments the system or part of the system according to the invention may be a suitably programmed computer. Likewise, some embodiments of the invention contemplate a computer program being readable by a computer for executing a method of the invention. Some embodiments of the invention further contemplate a machine-readable memory tangibly embodying a program of instructions executable by the machine for executing a method of the invention.

While the invention has been shown and described with respect to particular embodiments, it is not thus limited. Numerous modifications, changes and improvements within the scope of the invention will now occur to the reader.

1. A method of ranking an online user account, comprising:
ranking each of a group of posts owned by a user account as a function of quantity of online interactions with said post; and
ranking said user account as a function of said rank of each post owned by said user account in said group.

2. The method of claim 1, wherein said function of quantity of online interactions with said post includes weighting by type of interaction.

3. The method of any one of the preceding claims, wherein said function of quantity of online interactions with said post includes weighting by rank of interacting user.

4. The method of any one of the preceding claims, wherein said function of quantity of online interactions includes dividing quantity of interactions with said post by quantity of interactions with all posts in said group.

5. The method of any one of the preceding claims, wherein said function of quantity of online interactions includes weighting based on whether an interaction is owned or ownerless.

6. The method of any one of the preceding claims, wherein said rank of said post is also a function of age of said post.

7. The method of any one of the preceding claims, wherein said function of said rank of each post owned by said user account includes addition of ranks of all posts in said group owned by said user account.

8. The method of any one of the preceding claims, wherein said rank of said online user account is also a function of direct interactions by interacting user accounts.

9. The method of any one of the preceding claims, further comprising:
normalizing said rank of said user account by a function of quantity of user accounts and maximum user account rank

10. The method of any one of the preceding claims, further comprising:
determining a rank of a profile as a function of ranks of all online user accounts whose probability of corresponding to said profile is above a predetermined percentage.

11. The method of any one of the preceding claims, wherein said group includes all posts owned by said user account.

12. The method of any one of claims 1 to 10, wherein said group includes a subset of posts owned by said user account.

13. The method of any one of the preceding claims, further comprising at least one of the following:
sorting a plurality of ranked user accounts primarily, secondarily, or of even lesser importance by rank; or
selecting one or more ranked user accounts at least partly based on rank.

14. A system for ranking an online user account comprising:
at least one post ranker for ranking each of a group of posts owned by a user account as a function of quantity of online interactions with said post; and
at least one user account ranker for ranking said user account as a function of said rank of each post owned by said user account in said group.

15. A method of concluding that two online user accounts correspond to a common profile, comprising:
analyzing data relating to two online user accounts;
increasing a probability that said two online user accounts correspond to a common profile as more of said data suggests that said two user accounts correspond to a common profile; and
if a probability that said two online user accounts correspond to a common profile is above a predetermined threshold, concluding that said two online user accounts correspond to a common profile.

16. The method of claim 15, wherein said analyzed data includes identification by at least one other that said two online user accounts correspond to a common profile.

17. The method of claim 15 or 16, wherein said analyzed data includes at least one URI to one or more posts owned by one of said user accounts, listed in one or more posts owned by a second of said user accounts.

18. The method of any one of claims 15 to 17, wherein said analyzed data includes at least one relationship that both of said user accounts share with at least one specific profile, wherein for each relationship each of said user accounts may be related to the same user account or to a different user account corresponding to said specific profile.

19. The method of any one of claims 15 to 18, wherein said analyzed data includes identical information for said two user accounts.

20. The method of any one of claims 15 to 19, wherein said analyzed data includes authentication by possessor of said two user accounts that said two user accounts correspond to a common profile.

21. The method of any one of claims 15 to 20, further comprising:
if and when a probability that said two online user accounts correspond to a common profile first rises above a predetermined floor, automatically creating said common profile.

22. The method of any one of claims 15 to 21, further comprising:
if there is more than one user account in a particular external source with probability above zero of corresponding to a common profile with another user account, concluding that all user accounts in said particular external source, other than highest probability of corresponding user account, do not correspond to a common profile with said other user account.

23. A system for concluding that two online user accounts correspond to a common profile, comprising:
at least one counter for increasing a probability that two online user accounts correspond to a common profile as more data relating to two online user accounts suggests that said two user accounts correspond to a common profile; and
at least one comparer for analyzing data relating to two online user accounts and for concluding that said two online user accounts correspond to a common profile, if a probability that said two online user accounts correspond to a common profile is above a predetermined threshold.

24. The system of claim 23, further comprising:
a profile processor for automatically creating said common profile if and when a probability that said two online user accounts correspond to a common profile first rises above a predetermined floor.

25. A method of noting online roles of user accounts, comprising:
for at least one post from a group of posts:
noting at least one role played by a user account which owns said post; and
for at least one interaction from a collection of interactions with said post, noting at least one role played by associated interacting user account based on type of interaction.

26. The method of claim 25, wherein said noting a role includes:
increasing a measurement value for said role.

27. The method of claim 25 or 26, further comprising:
determining when a trend begins;
wherein said group and collection correspond to at least one of predetermined timeframe before trend began and predetermined timeframe after trend began.

28. The method of any one of claims 25 to 27, wherein said group includes all posts collected in a time period.

29. The method of any one of claims 25 to 27, wherein said group includes a subset of posts collected in a time period.

30. The method of any one of claims 25 to 29, further comprising at least one of the following:
sorting user accounts primarily, secondarily, or of even lesser importance, based on notations for at least one role;
or selecting one or more user accounts at least partly based on notations for at least one role.

31. A system for noting online roles of user accounts, comprising:
at least one counter for noting for at least one post from a group of posts at least one role played by a user account which owns said post; and for noting for at least one interaction from a collection of interactions with said post, at least one role played by associated interacting user account based on type of interaction.

32. A method of calculating alternative cost of funding a traditional online campaign that would lead to equivalent exposure with equivalent partiality as posts, comprising:
for each post relevant to an online campaign:
determining a partiality score of said post to said campaign; and
estimating cost of funding in a traditional campaign equivalent exposure at external source including post; and
calculating said alternative cost by summing said partiality score multiplied by said estimated cost for each post.

33. The method of claim 32, wherein said determining said partiality score includes:
determining said partiality score as a function of sentiment toward said campaign or to brand which is subject of said campaign.

34. The method of claim 32 or 33, wherein said determining said partiality score includes:
determining said partiality score as a function of quantity of keywords related to campaign or brand subject of said campaign and of quantity of keywords relating to competitor.

35. The method of any one of claims 32 to 34, wherein said partiality score for a post relates to said post and interactions with said post.

36. The method of any one of claims 32 to 35, wherein said estimating includes:
estimating said cost as a function of number of interactions per post by unique interacting user accounts.

37. The method of claim 36, wherein said function is also a function of number of views of post.

38. A system for calculating alternative cost of funding a traditional online campaign that would lead to equivalent exposure with equivalent partiality as posts, comprising:
at least one partiality scorer for determining a partiality score for each post relevant to an online campaign;
at least one traditional campaign cost estimator for estimating for each post a cost of funding in a traditional campaign equivalent exposure at external source which includes said post; and
at least one alternative cost calculator for calculating an alternative cost by summing said partiality score multiplied by said estimated cost for each post.

39. A method of management of an online campaign, comprising:
receiving a definition of a campaign;
selecting a subset of posts based on said definition; and
reporting at least one of the following:
at least one user account, said reporting reflecting user account rank as a function of rank of each post owned by said user account in said subset;
a user account who played a specific role as a post owner or interacting user account for at least one post in said subset;
a profile corresponding with a probability above a predetermined threshold to at least one user account, each of which own or interacted with at least one post in said subset; or
an alternative cost of funding a traditional online campaign that would lead to equivalent exposure with equivalent partiality as said subset of posts.

40. The method of claim 39, further comprising:
reporting at least one of the following: quantity of posts, quantity of conversations, quantity of interactions, demographics of user accounts, list of influencer user accounts, list of most active user accounts, related tags, and sentiment analysis.

41. The method of claim 39 or 40, wherein said definition of a campaign includes defining at least one selected from a group comprising: brand, competition, ecosystem, campaign specific content, user accounts.

42. The method of any one of claims 39 to 41, wherein said predetermined threshold is less than 100%.

43. A system for management of an online campaign, comprising:
an application for receiving a definition of a campaign;
an index searcher for searching an index to select a subset of posts based on said definition; and
a reporting module for reporting at least one of the following:
at least one user account, said reporting reflecting user account rank as a function of rank of each post owned by said user account in said subset;
a user account who played a specific role as a post owner or interacting user account for at least one post in said subset;
a profile corresponding with a probability above a predetermined threshold to at least one user account, each of which owns or interacted with at least one post in said subset; or
an alternative cost of funding a traditional online campaign equivalent in exposure with equivalent partiality as said subset of posts.

44. A computer program comprising computer program code means for performing all the steps of any one of claims 1 to 13, 15 to 22, 25 to 30, 32 to 37, or 39 to 42 when said program is run on a computer.

45. A computer program as claimed in claim 44, embodied on a computer readable medium.
